(19) United States
(12) Patent Application Publication
(10) Pub. No.: US 2026/0350690 A1
(43) Pub. Date: Nov. 5, 2026

(54) REMOTE TRY-ON WARDROBE MANAGEMENT AND CUSTOMIZATION

(71) Applicant: SpreeAI Corporation, Incline Village, NV (US)

(72) Inventors: Bo Kyung Kim, Brooklyn, NY (US); Danel Dominguez Sullivan, San Diego, CA (US); Tiffany Seojin Kwak, Lawrenceville, GA (US); Minh Phuoc Vo, Alameda, CA (US); Vinh Quang Tran, Woodside, NY (US); Chi Nhan Duong, Brossard (CA)

(73) Assignee: SpreeAI Corporation, Incline Village, NV (US)

(21) Appl. No.: 19/194,129

(22) Filed: Apr. 30, 2025

(51) Int. Cl. G06Q 30/0601; A45D 44/00; G06F 40/20; G06V 10/82; G06V 40/10

(52) U.S. Cl. CPC G06Q 30/0643; A45D 44/005; G06F 40/20; G06Q 30/0621; G06V 10/82; G06V 40/10

(57) ABSTRACT

In one implementation of remote try-on wardrobe management and customization, a processing device receives an image of a subject person (e.g., an individual browsing garments online) wearing a first clothing item. The processing device additionally receives an identification of a second clothing item in a virtual wardrobe, e.g., based on a user selection of the second clothing item. A machine-learning model generates a digital representation of the subject person wearing the second clothing item based on the image of the subject person and a digital image of the second clothing item. The processing device presents the digital representation of the subject person wearing the second clothing item in a user interface of a try-on wardrobe application allowing a user to manage and customize the virtual wardrobe on the subject person.

### BACKGROUND

Clothing sizes can vary significantly across different brands, and even within the same brand. This means that one size of a particular clothing item from a certain brand might fit a person well, but the same size from another brand might not fit the person well. Traditionally, individuals have been able to access garments in-person to wear the garments and view how the garments fit. In-person access to garments has also traditionally supported simultaneous try-on of different types of garments. However, the increasing trend of individuals acquiring garments online or from remote locations has led to difficulties with assessing how garments may appear while worn. Additionally, acquiring garments online or remotely can cause difficulties with assessing how different garments look and fit while worn together.

### SUMMARY

Techniques and systems for remote try-on wardrobe management and customization are described. In one example, a processing device receives an image of a subject person (e.g., an individual browsing garments online) wearing a first clothing item. The processing device additionally receives an identification of a second clothing item in a virtual wardrobe, e.g., based on a user selection of the second clothing item. A machine-learning model generates a digital representation of the subject person wearing the second clothing item based on the image of the subject person and a digital image of the second clothing item. The processing device presents the digital representation of the subject person wearing the second clothing item in a user interface of a try-on wardrobe application allowing a user to manage and customize the virtual wardrobe on the subject person.

This Summary introduces a simplified selection of concepts described below in the Detailed Description. As such, this Summary is not intended to identify essential features of the claimed subject matter or to aid in determining its scope.

### BRIEF DESCRIPTION OF THE DRAWINGS

The detailed description is described regarding the accompanying figures. Entities represented in the figures indicate one or more entities; thus, reference is made interchangeably to single or plural forms of the entities in the discussion.

FIG. 1 illustrates a digital medium environment in an example implementation that is operable to employ remote try-on wardrobe management and customization techniques as described herein.

FIG. 2 depicts a system in an example implementation that shows the operation of a try-on management service of FIG. 1 in greater detail, employing the techniques described herein.

FIG. 3 depicts a system in an example implementation showing the operation of an image touch-up service of the remote provider system of FIG. 1 in greater detail.

FIG. 4 depicts a system in an example implementation showing the operation of a background service of the remote provider system of FIG. 1 in greater detail.

FIG. 5 depicts a system in an example implementation showing the operation of a wardrobe service of the remote provider system of FIG. 1 in greater detail.

FIG. 6 depicts a system in an example implementation showing the operation of a garment scanning service of the remote provider system of FIG. 1 in greater detail.

FIG. 7 depicts a system in an example implementation showing the operation of a recommendation service of the remote provider system of FIG. 1 in greater detail.

FIG. 8 depicts a system in an example implementation showing the operation of an outfit comparison service of the remote provider system of FIG. 1 in greater detail.

FIG. 9 depicts a system and procedure in an example implementation for training a machine-learning model.

FIGS. 10 through 12 depict an example user interface employing the techniques described herein for image touch-up.

FIGS. 13 through 15 depict an example user interface employing the techniques described herein for pose transfer.

FIGS. 16 through 18 depict an example user interface employing the techniques described herein for image background adjustment.

FIGS. 19 through 22 depict an example user interface employing the techniques described herein for remote garment try-on.

FIGS. 23 and 24 depict an example user interface employing the techniques described herein for garment scanning.

FIGS. 25 through 29 depict an example user interface employing the techniques described herein for garment layering.

FIGS. 30 through 32 depict an example user interface employing the techniques described herein for recommendation generation.

FIGS. 33 through 35 depict an example user interface employing the techniques described herein for garment comparison.

FIG. 36 is a flow diagram depicting an algorithm as a step-by-step procedure in an example implementation of operations performable for accomplishing a result of remote try-on wardrobe management and customization.

FIG. 37 illustrates an example system including various components of an example device that can be implemented as any type of computing device as described and/or utilized concerning the previous figures to implement embodiments of the techniques described herein.

### DETAILED DESCRIPTION

### Overview

Ordering garments remotely, such as through a garment provider over the Internet, can be both convenient and frustrating. On one hand, it offers unmatched convenience and the ability to browse numerous options. However, this convenience comes with its fair share of frustrations. For instance, one of the biggest challenges is being unable to physically try on the clothes before purchasing. Some garments can look differently when viewed from different angles. Additionally, even garments that are of a same type, such as shirts, can fit differently depending on the brand or manufacturer. In some instances, it can also be difficult to determine how garments may appear when worn in different scenarios. For example, some garments can have a more casual appearance while other garments can have a more formal appearance. Further, differences in the appearances of garments when viewed remotely can make it difficult to assess whether the garments might aesthetically match other garments that are already owned. This can make it difficult to assess how garments will fit and look while worn and can lead to inconveniences such as returning or exchanging garments, incurring additional costs, and wasting time. Attempts to address these issues often have difficulties of their own, such as a lack of available information about the particular fit of garments.

Garment providers and manufacturers often provide sizing charts that display a garment's measurements in different sizes. These charts typically include key measurements like chest, waist, hips, inseam, and/or sleeve length, and indicate which size (e.g., small (S), medium (M), large (L), etc.) corresponds to each range of body measurements. Sizing charts are intended to assist viewers, especially individuals browsing online, with choosing well-fitting clothes. However, sizing charts can be difficult to navigate because sizing varies across brands and body types. Because they generally focus on a few key measurements, sizing charts do not account for other factors like body shape, height, and personal preferences.

In order to provide additional information regarding how garments fit and drape, some garment providers will provide digital images that show garments worn by human models or mannequins. However, even when such images are made available to individuals browsing garments online, it can be difficult for individuals to determine how garments would appear on their own bodies. For instance, digital images may depict a “small” size garment worn by a human model or mannequin, but individuals that typically wear “medium” or “large” size garments may have trouble visualizing how these larger sizes might fit. Additionally, even if a garment provider provides digital images showing different human models or mannequins wearing a garment, differences between the human models or mannequins such as torso size, leg length, shoulder length, and so forth can lead to uncertainties as to how the garment will appear on an individual viewing the garment online. These difficulties can be further complicated when garments are depicted in a single view or a small number of views that poorly depict the shape of the garment from different perspectives.

In contrast, the described techniques for remote try-on wardrobe management and customization use machine-learning to implement various operations that increase an accuracy of remote representation of garments. A single uploaded or saved image of an individual is received by a processing device implementing a try-on management service, and machine-learning is used to process the image for generation of representations of the individual wearing garments and/or in various poses. In some instances, machine-learning is used to generate representations showing the individual in different environments and/or with adjustments to aspects of individual appearance such as skin tone or cosmetics. The try-on management service maintains the various generated representations, garment selections, outfit selections, and other data. In some instances, such information can be employed by the service for generation of additional representations, recommendations for garments, and/or identification of garments belonging to the individual. In this way, individuals can view how garments would appear on themselves in a variety of scenarios, and a computational load and/or processing time of the processing device can be reduced.

The following discussion describes an example environment that employs the techniques described herein. Example procedures are also described as performable in the example environment and other environments. Consequently, the performance of the example procedures is not limited to the example environment, and the example environment is not limited to the performance of the example procedures.

### Example Remote try-on Wardrobe Management and Customization Environment

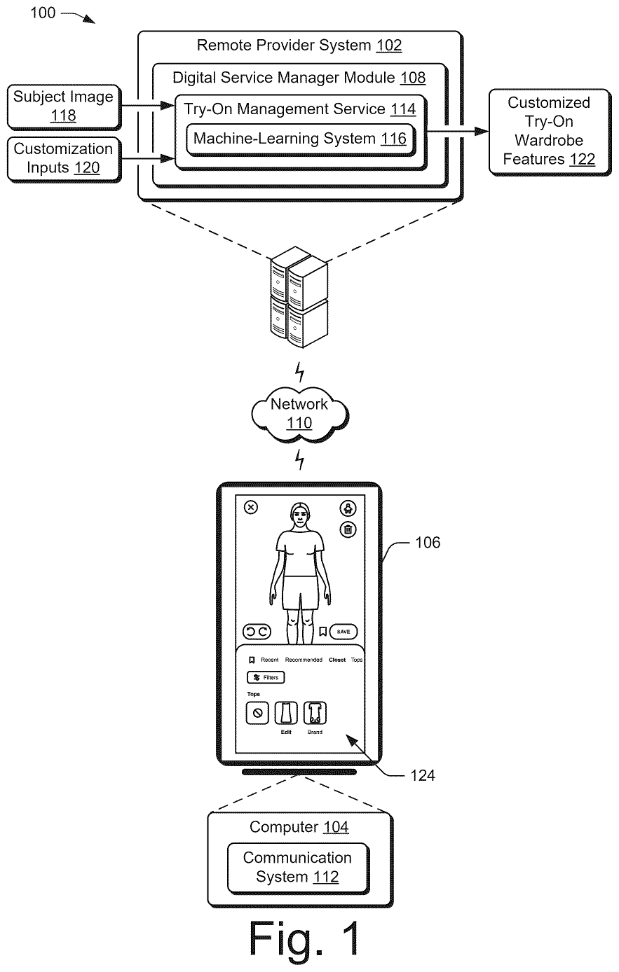

FIG. 1 illustrates a digital medium environment 100 in an example implementation that is operable to employ the remote try-on wardrobe management and customization techniques described herein. The illustrated digital medium environment 100 includes a remote provider system 102 and a computer 104 that are communicatively coupled, one to another, via the Internet or another wired or wireless network. The computer 104 is operable to present (e.g., display) information communicated from the remote provider system 102 via a display 106. Computing systems for the remote provider system 102 and the computer 104 are configurable in various ways. For instance, the computer 104 is associated with a user, and the remote provider system 102 is a remote computing system (e.g., one or more servers) configured to employ the described techniques and systems for remote try-on wardrobe management and customization.

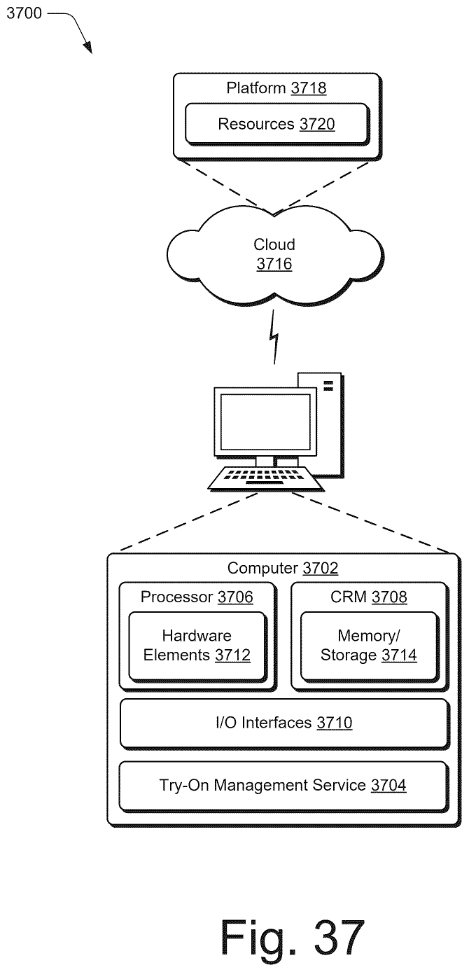

A computing system, for instance, is configurable as a desktop computer, laptop computer, mobile device (e.g., assuming a handheld configuration such as a tablet or mobile phone), server, and so forth. Thus, the remote provider system 102 or the computer 104 can range from a full-resource device with substantial memory and processor resources (e.g., servers and personal computers) to a low-resource device with limited memory and/or processing resources (e.g., some mobile devices). Additionally, although a single computing device is shown for the computer 104 and described in instances in the following discussion, a computing system is also representative of a plurality of different devices, such as multiple servers utilized by a business to perform operations “over the cloud” for the remote provider system 102 and as further described in relation to FIG. 37.

The remote provider system 102 includes a digital service manager module 108 implemented using hardware and software resources (e.g., a processing device and computer-readable storage medium) to support one or more digital services (e.g., an online marketplace). The digital services are made available remotely via a network 110, such as the Internet, to computing devices (e.g., computer 104).

The digital services are scalable through implementation by the hardware and software resources and support a variety of functionalities, including accessibility, verification, real-time processing, analytics, load balancing, and so forth. Examples of digital services include a social media service, online marketplace, streaming service, digital content repository service, content collaboration service, and so on. Accordingly, in the illustrated example, a communication system 112 (e.g., browser, network-enabled application, and so on) is utilized by the computer 104 to access digital services via the network 110. The result of processing using the digital services is then returned to the computer 104 via the network 110.

In the illustrated digital medium environment 100, the digital services include a try-on management service 114 for assisting online purchasers in management of a remote (e.g., virtual) try-on wardrobe. The try-on management service 114 may be implemented in hardware and/or software of the remote provider system 102 (e.g., as an application). The try-on management service 114 may be referred to herein as a try-on wardrobe application, for instance.

The try-on management service 114 facilitates communication between various services implemented by the remote provider system 102 to support various functionality provided by the try-on wardrobe. For example, the try-on management service 114 uses a machine-learning system 116 to process a subject image 118 and customization inputs 120 to generate customized try-on wardrobe features 122. The customized try-on wardrobe features 122 can then be presented by way of a virtual wardrobe 124.

The virtual wardrobe 124 can be implemented by the try-on management service 114 by way of a user interface (e.g., user interface 1000 described further below). The virtual wardrobe 124 is configurable to specify one or more garments (e.g., a set of garments) and/or outfits managed via the try-on management service 114 for virtual try-on, purchase, and/or other operations. Garments may also be referred to herein as apparel. Garments and outfits can be added to the virtual wardrobe 124 by way of user selection at least in some instances. For example, garments viewed within the user interface 1000 described below can be selected using a user input device (e.g., mouse, keyboard, trackpad, etc.) to be included in the virtual wardrobe 124. The garments and/or outfits in the virtual wardrobe 124 can be used for generation of representations of the individual depicted by the subject image 118 wearing the garments and/or outfits. Such representations may be referred to herein as composite images and/or synthesized images, in some instances. The try-on management service 114 supports management of the virtual wardrobe 124 (e.g., addition of garments to the virtual wardrobe 124 and/or removal of garments from the virtual wardrobe 124). The try-on management service 114 additionally supports customization of the virtual wardrobe 124 on the individual depicted in the subject image 118 (e.g., generation of representations showing one or more of the garment worn by the individual, customization of patterns and/or colors of such garments in such representations, customization of the pose of the individual, and so forth).

Given the subject image 118 capturing an image of an individual (e.g., a user of the try-on management service 114) and the customization inputs 120, the try-on management service 114 generates the customized try-on wardrobe features 122 that can include various representations of the individual in different poses and/or wearing different garments, customized backgrounds, recommendations for garments and/or garment sizes, and other features as described herein. Configuration of the customized try-on wardrobe features 122 can be performed in some instances by way of the user's interaction with a user interface (UI) displayed by the computer 104. For example, the user interface can be communicated to the computer 104 from the remote provider system 102 and can support selection of the customization inputs 120 provided to the try-on management service 114 for configuring the customized try-on wardrobe features 122.

As previously described, conventional online marketplaces generally just provide a sizing chart with limited measurements to assist users in selecting an appropriate size and/or determining if a clothing item will fit the user as desired. In the described remote try-on wardrobe management and customization techniques, however, the customized try-on wardrobe features 122 give users greater confidence in selecting clothing sizes and items that fit them well and match a desired style. Further, the customized try-on wardrobe features 122 provide a variety of functionality that can support identification of other garments that may be of interest to the user, comparison of outfits, recommendations for particular sizes and/or particular shapes of garments, and so forth.

To do so, the try-on management service 114 is configurable to employ the machine-learning system(s) 116 to determine a user's dimensions (e.g., chest size, shoulder width, etc.) from a single uploaded image (e.g., the subject image 118). The user's dimensions are used to generate a mesh model of the user, which is then used by the same machine-learning system 116 or another machine-learning system to generate representations of the user wearing clothing items. This machine-learning system 116 can use apparel details (e.g., various measurements) to determine a fit of the clothing items on the mesh model representation of the user. In some situations, the representations can indicate the clothing's fit (e.g., using a heat map showing areas of tightness or looseness on different portions of the digital body).

The try-on management service 114 thus supports the generation of multiple representations of the user wearing various clothing items from a single subject image. The subject image and representations are managed via the try-on management service 114 and can be used to support functionality of various services employed by the try-on management service 114. For example, using the single subject image 118, the try-on management service 114 is operable to generate representations of the user in various environments, in various poses, wearing various garments, and so forth as described below. Additionally, representations that are generated can be used to expedite generation of subsequent representations and/or configuration of other features, thereby increasing system performance. Further discussion of these and other examples is included in the following section and shown in the corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Remote try-on Wardrobe Management and Customization

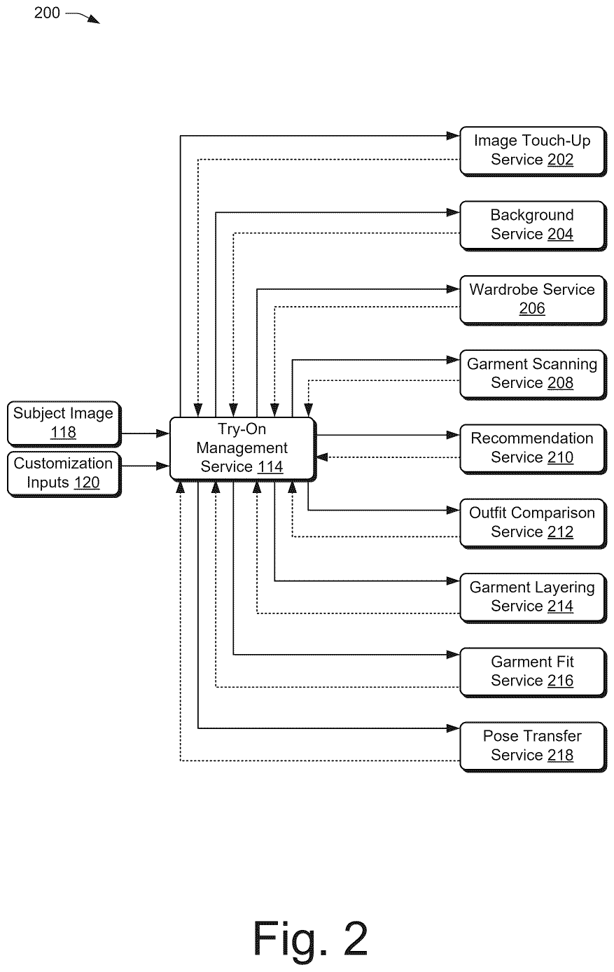

FIG. 2 depicts a system 200 in an example implementation showing the operation of the try-on management service 114 of FIG. 1 as employing the techniques described herein. The try-on management service 114 is configurable to implement a pipeline to address technical challenges, supporting a variety of functionality for remote try-on wardrobe management. To do so, the try-on management service 114 communicates with (and exchanges data between) various services implemented by the remote provider system 102. In the depicted example, the try-on management service 114 is in electronic communication with an image touch-up service 202, a background service 204, a wardrobe service 206, a garment scanning service 208, a recommendation service 210, an outfit comparison service 212, a garment layering service 214, a garment fit service 216, and a pose transfer service 218.

The try-on management service 114 is configured to receive the subject image 118 as described above. Using the single subject image 118, the try-on management service 114 is operable to provide a variety of functionality by controlling the services depicted by FIG. 2 based on the customization inputs 120. The try-on management service 114 is further operable to receive output from one or more of the services and provide the output to other services along with corresponding customization inputs 120 to expedite generation of additional content and/or reduce resources of the remote provider system 102 used for generation of the additional content. In the depicted example, information communicated from the try-on management service 114 to other services is indicated by solid lines with arrows, and information communicated from the other services to the try-on management service 114 is indicated by dotted lines with arrows. Various non-limiting examples of information communicated between the try-on management service 114 and the other services are described below.

The image touch-up service 202 may be employed by the try-on management service 114 for generating representations of the individual depicted by the subject image 118 with adjustments to skin tone, cosmetics, and/or other features. The background service 204 may be employed by the try-on management service 114 for generating representations of the individual in different environments, e.g., with different backgrounds defining different environments. The wardrobe service 206 may be employed by the try-on management service 114 for management of garment selections (also referred to as apparel selections) associated with users and stored representations of individuals (e.g., the individual depicted by the subject image 118). The recommendation service 210 may be employed by the try-on management service 114 for generation of recommendations and responses to user queries. The outfit comparison service 212 may be employed by the try-on management service 114 for comparison of outfits stored to the try-on wardrobe (e.g., outfits including garments managed via the wardrobe service 206).

The garment layering service 214 can be employed by the try-on management service 114 for generation of representations of the individual depicted in the subject image 118 wearing multiple garments (also referred to herein as clothing items and/or apparel) concurrently based on garment selections specified in the customization inputs 120. Garment layering as implemented by the garment layering service 214 is described in greater detail in U.S. patent application Ser. No. 18/962,200, filed on Nov. 27, 2024, and is hereby incorporated in its entirety herein.

The garment fit service 216 can be employed by the try-on management service 114 for determining a fit of one or more garments when worn by the individual depicted in the subject image 118. Garment fitting as implemented by the garment fit service 216 is described in greater detail in U.S. patent application Ser. No. 19/003,483, filed on Dec. 27, 2024, and is hereby incorporated in its entirety herein.

The pose transfer service 218 can be employed by the try-on management service 114 for generating representations of the individual depicted by the subject image 118 in different poses. Such representations may be referred to herein as pose-transferred images. Pose-transferred images depicting the individual wearing garments different than the garments worn by the individual in the source image for the pose-transferred image (e.g., the subject image 118) may be referred to herein as composite images and/or synthesized images, in some instances. Pose transfer as implemented by the pose transfer service 218 is described in greater detail in U.S. patent application Ser. No. 19/056,487, filed on Feb. 18, 2025, and is hereby incorporated in its entirety herein.

The recommendation service 210 can be employed by the try-on management service 114 for generation of recommendations including a variety of information. For instance, recommendations may depict heat maps overlaid with the subject image 118 to indicate a fit of garments when worn by the individual depicted by the subject image 118. Such heat maps as implemented by the recommendation service 210 are described in greater detail in U.S. patent application Ser. No. 18/787,363, filed on Jul. 29, 2024, and is hereby incorporated in its entirety herein. For instance, the recommendation service 210 may employ a digital fitting service for the generation of heat maps.

In some instances, one or more of the services may be combined and/or operate in tandem. For example, the garment fit service 216 may be combined with the garment layering service 214 as a single garment fit and layering service. In some instances, multiple services may employ the same machine-learning models, and/or multiple machine-learning models described herein may be combined. As one non-limiting example, a generative adversarial network (GAN) employed by the garment layering service may be used to generate representations of the individual depicted by the subject image 118 wearing multiple garments, and the same GAN may be employed by the pose transfer service 218 for depicting garments on pose-transferred representations of the individual. Other examples are possible.

The outputs of various services can be communicated back to the try-on management service 114 in order to facilitate faster processing of subsequent operations performed using the services employed by the try-on management service 114. For example, consider a scenario in which the try-on management service 114 is provided the single subject image 118. The customization inputs 120 are received specifying adjustment of the appearance of the individual depicted by the subject image 118, e.g., adjustment of a skin tone of the individual. Responsive to receiving the customization inputs 120, the try-on management service 114 employs the image touch-up service 202 to generate a representation of the individual with the adjusted appearance. In some instances, the representation may be stored as a separate digital image of the individual. In some instances, the adjustments may be stored as image adjustment instructions that are readable by the other services employed by the try-on management service 114. For example, such image adjustment instructions can be communicated to support adjustment of a variety of representations of the individual in addition to the subject image 118.

Following generation of the representation of the individual with the adjusted appearance, additional customization inputs 120 are received specifying an environment for the individual. Responsive to receiving the additional customization inputs 120, the try-on management service 114 employs the background service 204 to generate another representation of the individual in the environment specified by the additional customization inputs 120. To do so, the try-on management service 114 provides the background service 204 with the representation generated by the image touch-up service 202 as input. In some instances, the image adjustment instructions described above are provided to the background service 204 for generation of the additional representation. As a result, the representation output by the background service 204 depicts the individual in the specified environment with the adjustments to the appearance of the individual provided by the image touch-up service 202.

Following generation of the representation by the background service 204, further customization inputs 120 are received specifying a pose for the individual. Responsive to receiving the customization inputs 120 specifying the pose, the try-on management service 114 employs the pose transfer service 218 to generate another representation that shows the individual in the specified pose. To do so, the try-on management service 114 provides the pose transfer service 218 with the representation generated by the background service 204 that depicts the individual in the environment with the adjustments to the appearance provided by the image touch-up service 202. The pose transfer service 218 generates a subject mesh model for the individual, and the resulting representation of the individual in the specified pose also depicts the individual in the specified environment with the specified adjustments to the appearance of the individual. Thus, the try-on management service 114 can control the other services to generate complex representations of the individual using the single subject image 118.

Continuing with this scenario, additional customization inputs 120 are received specifying garments to be depicted as worn by the individual. Responsive to receiving the additional customization inputs 120, the try-on management service 114 provides the subject mesh model previously generated by the pose transfer service 218 to the garment layering service 214. The try-on management service 114 additionally provides the representation of the individual in the specified pose and environment with the specified adjustments to appearance to the garment layering service 214. The garment layering service 214 then outputs a representation of the individual wearing the specified garments in the specified pose and environment with the specified adjustments to appearance.

By controlling the services as described above, the try-on management service 114 is able to re-use assets generated by services for operations performed by other services. As a result, a computational load (e.g., consumption of resources such as memory, processors, etc.) of the remote provider system 102 can be reduced, and performance of the remote provider system 102 can be increased.

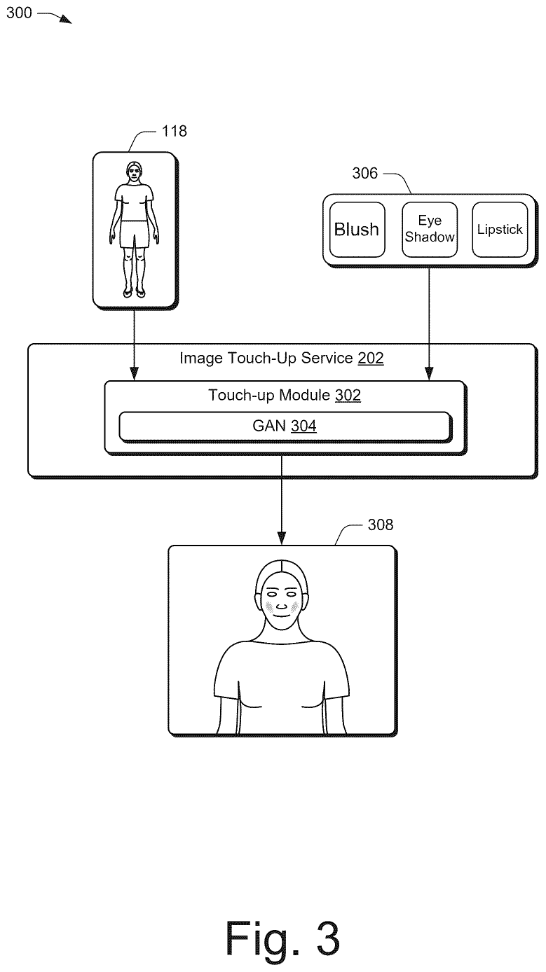

FIG. 3 depicts a system 300 in an example implementation showing the operation of the image touch-up service 202 of the remote provider system 102 of FIG. 1 in greater detail. The image touch-up service 202 is configurable to implement a pipeline to address technical challenges, supporting the generation of images from the subject image 118 that depict an individual shown by the subject image with adjustments to skin tone, cosmetics, and/or other features. To do so, the image touch-up service 202 employs a touch-up module 302 and a GAN 304. Although the GAN 304 is depicted, in some instances the touch-up module 302 may employ a convolutional neural network (CNN), generative diffusion model, or other type of machine-learning model for the generation of images as described herein.

The touch-up module 302 is configured to receive the subject image 118 and adjustment data 306. The adjustment data 306 describes one or more selections for adjustment (e.g., touch-up) of the representation of the subject person depicted by the subject image 118. The subject image 118 and the adjustment data 306 can be provided to the touch-up module 302 by the try-on management service 114.

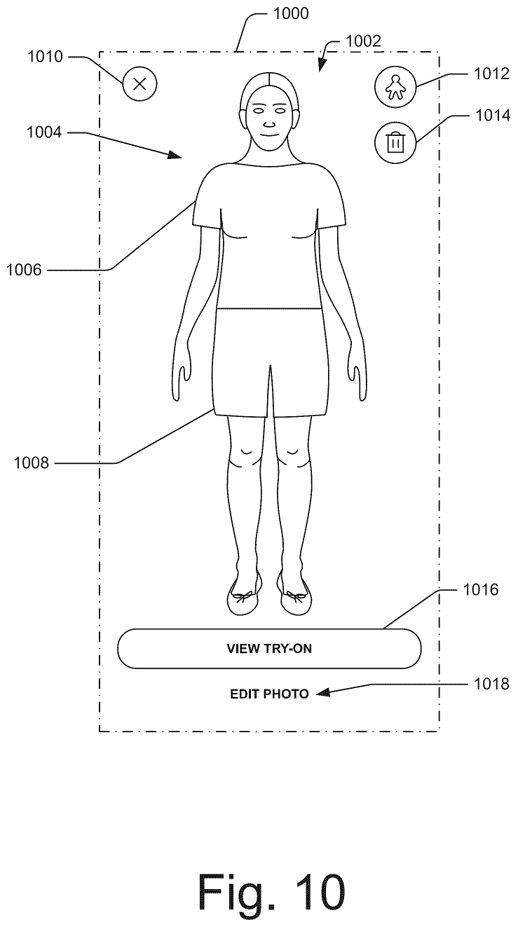

As one example, the try-on management service 114 is operable to cause presentation (e.g., display) of a user interface at a user device (e.g., the computer 104) that is in electronic communication with the remote provider system 102. The subject image 118 can be provided to the try-on management service 114 (e.g., uploaded to the remote provider system 102) over the network 110 from the user device via the user interface. Additionally, inputs to the user interface can specify selections for adjustment of the representation of the subject person depicted by the subject image 118 as described further below with reference to FIGS. 10-12. The adjustment data 306 may be generated by the try-on management service 114 based on the inputs to the user interface. The subject image 118 and the adjustment data 306 are communicated from the try-on management service 114 to the touch-up module 302 for the operations employing the touch-up module 302 as described herein.

The touch-up module 302 uses the GAN 304 to synthesize the selected adjustments on the subject image 118 to obtain photo-realistic results in an output image 308 generated by the touch-up module 302. The GAN 304 is robust to occlusion (e.g., caused by hair, arms, etc.) in the subject image 118 and can fill in the missing information during the synthesis process. The adjustments can include, for example, photo-realistic additional or removal of cosmetics from the face of the individual depicted in the subject image 118 (e.g., blush, lipstick, eyeliners, etc.), photo-realistic adjustment of skin tone (e.g., pigmentation, freckles, shading, etc.), and so forth. Once generated by the touch-up module 302, the output image 308 can be provided to the try-on management service 114 for use in other operations using other services employed by the try-on management service 114. For example, the output image 308 may be selected as a substitute for the subject image 118 in various operations such as background selection via the background service 204, garment layering via the garment layering service 214, pose transfer via the pose transfer service 218, and so forth.

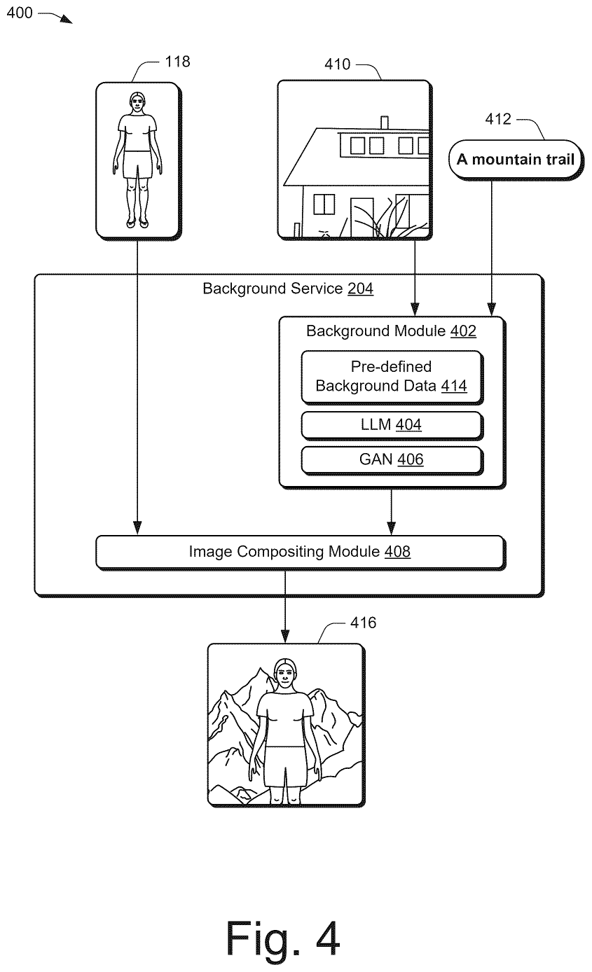

FIG. 4 depicts a system 400 in an example implementation showing the operation of the background service 204 of the remote provider system 102 of FIG. 1 in greater detail. The background service 204 is configurable to implement a pipeline to address technical challenges, supporting the generation of images from the subject image 118 that depict an individual shown by the subject image with backgrounds based on user selections and/or natural language input. To do so, the background service 204 employs a background module 402, a large language model (LLM) 404, a GAN 406, and an image compositing module 408. Although the GAN 406 is depicted, in some instances the background module 402 may employ a CNN, generative diffusion model, or other type of machine-learning model.

The background module 402 is configured to receive the subject image 118. The background module 402 additionally receives a background selection 410 and/or natural language input 412 describing a scene to be used as a background for the individual depicted by the subject image 118.

The background selection 410 specifies a background known to the background service 204. Pre-defined background data 414 is accessible to the background module 402 (e.g., stored in a memory of the remote provider system 102, stored to cloud storage, etc.). The pre-defined background data 414 includes various backgrounds that can be selected as the background selection. The pre-defined background data 414 may additionally include information describing lighting conditions, weather effects, animations, occlusion layers, and/or other information associated with the backgrounds. Following input of the background selection 410, the subject image 118 is composited with the background selection 410 by an image compositing module 408 to generate a representation of the individual depicted by the subject image 118 in the environment of the background selection 410. The representation may be referred to herein as a composite image and/or synthesized image, in some instances. The image compositing module 408 may include one or more GANs, CNNs, or other machine-learning models trained to generate the representation that photo-realistically depicts the individual depicted by the subject image in the environment defined by (e.g., depicted by) the background selection 410. In some instances, the image compositing module 408 can adjust the lighting of the individual depicted by the subject image to appear convincingly within the environment of the background selection 410 using the information describing the lighting conditions. Further, in some instances, the representation may include animation of features of the background selection 410, weather effects, and so forth.

In some situations, natural language input 412 is received by the background module 402. The natural language input 412 can specify a scene to be depicted as the background for the individual depicted in the subject image 118. In the example shown, the natural language input 412 describes “a mountain trail.” The background module 402 processes the natural language input 412 using the LLM 404 and determines a context of the natural language input 412. Determining the context includes, for example, determining objects, environments, and/or other features described by the natural language input 412. The background module 402 then employs the GAN 406 (or another machine-learning model, such as a generative diffusion model) to generate the background described by the natural language input 412 using the context determined by the LLM 404. In the depicted example, the GAN 406 is employed to generate a background depicting a mountain trail. The background and the subject image 118 are provided to the image compositing module 408 which generates a photo-realistic depiction of the individual depicted by the subject image 118 in the background depicting the mountain trail, shown in the example as output image 416. As described above, the output image 416 may be referred to herein as a composite image and/or synthesized image, in some instances. Similar to the example described above, the image compositing module 408 can adjust the lighting of the individual depicted by the subject image 118 based on the lighting of the background generated by the background module 402 such that the output image 416 convincingly depicts the individual in the environment of the background (e.g., the mountain trail). Further, the output image 416 may include weather effects, animation, and/or other features similar to the example described above.

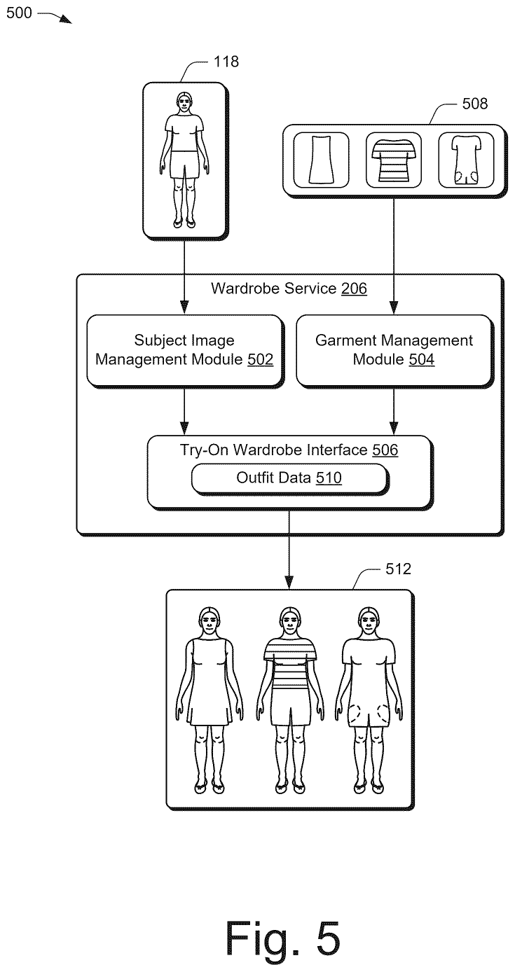

FIG. 5 depicts a system 500 in an example implementation showing the operation of the wardrobe service 206 of the remote provider system 102 of FIG. 1 in greater detail. The wardrobe service 206 is configurable to implement a pipeline to address technical challenges, supporting the management of garment selections and representations of the individual depicted by the subject image 118 wearing various garments. To do so, the wardrobe service 206 employs a subject image management module 502 and a garment management module 504. The wardrobe service 206 further implements a try-on wardrobe interface 506. The try-on wardrobe interface 506 is part of the user interface implemented by the try-on management service 114. The representations may be referred to herein as composite images and/or synthesized images, in some instances.

The subject image management module 502 is configured to receive the subject image 118, and the garment management module 504 is configured to receive one or more garment selections 508. The subject image management module 502 is employed by the wardrobe service 206 for management and selection of representations of the individual depicted by the subject image 118 that are generated by way of other services such as the image touch-up service 202, the background service 204, the pose transfer service 218, and so forth. For example, the representations can be selected for use with other services via the try-on wardrobe interface 506.

The garment management module 504 is employed by the wardrobe service 206 for management of garments associated with users and/or user accounts. As an example, a user navigating the user interface implemented by the try-on management service 114 (e.g., via communication between the remote provider system 102 and the computer 104) may be associated with a user account. The user account may be one of multiple user accounts maintained by the remote provider system 102, where different user accounts can be associated with different users. While navigating the user interface, user input specifies the garment selections 508 (e.g., via selection of garments from garment listings, selection of images of the garments, etc.). The garment selections 508 are provided to the garment management module 504, and the garment management module 504 associates the garment selections 508 with the user account of the user. Information associated with the garments specified by the garment selections 508 such as sizes, colors, patterns, prices, brands, and so forth can be viewed via the try-on wardrobe interface 506. Further, the try-on wardrobe interface 506 can be used to associate additional garment selections with the user account or remove association of garment selections with the user account.

Outfit data 510 is accessible to the wardrobe service 206 for presentation (e.g., display) and management of outfits 512 via the try-on wardrobe interface 506. Each outfit includes one or more garments from the garment selections 508. For example, user input may specify two garments from the garment selections 508 to be included in a single outfit. The try-on wardrobe interface 506 supports display of the individual depicted in the subject image 118 wearing the various garments and outfits. In some instances, each garment associated with a particular outfit can be selected for purchase by way of selection of the outfit using the try-on wardrobe interface 506.

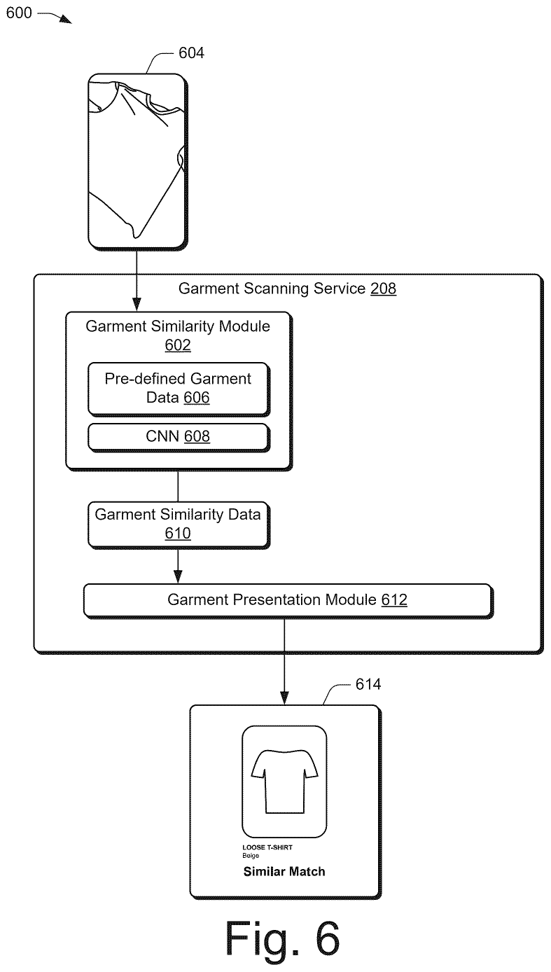

FIG. 6 depicts a system 600 in an example implementation showing the operation of the garment scanning service 208 of the remote provider system 102 of FIG. 1 in greater detail. The garment scanning service 208 is configurable to implement a pipeline to address technical challenges, supporting the scanning, identification, and presentation of garments. To do so, the garment scanning service 208 employs a garment similarity module 602 and a garment management module 504.

The garment similarity module 602 is configured to receive a garment image 604. In some instances, the garment image 604 may be acquired by a user device including an image sensor, such as a smartphone, tablet, webcam, and so forth. In some situations, acquisition of the garment image 604 may occur substantially in real-time, e.g., as part of a sequence of image frames acquired while moving the user device within an environment. In some instances, the garment image may be acquired from a webpage or other location accessible via the network 110.

The garment similarity module 602 is able to access pre-defined garment data 606. For example, the pre-defined garment data 606 may be stored in a memory of the remote provider system 102, stored in cloud storage accessible to the remote provider system 102, and so forth. The pre-defined garment data 606 includes information describing garments that are available for selection via the user interface implemented by the try-on management service 114. For example, the pre-defined garment data 606 may describe garment sizes, colors, patterns, shapes, brand, and so forth.

The garment similarity module 602 includes a CNN 608. The garment similarity module 602 employs the CNN 608 to determine garments that are similar to the garment depicted by the garment image 604. To do so, the CNN 608 is trained on data describing various types of garments. Such data may include, for example, digital images of shirts, pants, outerwear, shoes, hats, and so forth. In some instances, the CNN 608 is trained at least in part using the pre-defined garment data 606.

The garment similarity module 602 processes the garment image 604 using the CNN 608 and compares features of the garment depicted by the garment image 604 with features of garments described by the pre-defined garment data 606. Based on the comparison, the garment similarity module 602 determines one or more garments that have features similar to the features of the garment depicted by the garment image 604. In some instances, the similar garments may be assigned scores, with higher scores corresponding to greater similarity to the garment depicted by the garment image 604, and with lower scores corresponding to less similarity to the garment depicted by the garment image 604.

The garment similarity module 602 provides garment similarity data 610 to a garment presentation module 612. The garment similarity data 610 describes one or more garments having a high amount of similarity to the garment depicted by the garment image 604. For example, the garment similarity data 610 may describe several garments and may further specify the similarity score associated with the garments. The garment presentation module 612 is employed by the garment scanning service 208 for presenting (e.g., displaying) one or more garments (e.g., related garment 614) based on the processing of the garment image 604 described above. In particular, the garment presentation module 612 receives the garment similarity data 610 and determines, from the garment similarity data 610, one or more related garments to present. In some instances, the garment presentation module 612 may present a garment described by the garment similarity data 610 that has a highest similarity score. In some instances, the garment presentation module 612 may present each garment described by the garment similarity data 610 that has a similarity score above a pre-defined threshold similarity score. In some instances, the garment depicted by the garment image 604 is described by the pre-defined garment data 606, and as a result, the garment similarity module 602 is able to determine an exact match of the garment to be presented as the related garment 614.

The one or more related garments can be selected to be included in the try-on wardrobe associated with the user or user account. For example, the related garment 614 can be selected to be added to the outfit data 510 and/or presented in the try-on wardrobe interface 506. The related garment 614 can be selected for virtual try-on, e.g., representations of the individual depicted by the subject image can be generated in which the individual wears the related garment 614. In some instances, the related garment 614 can be selected for purchase.

In some instances, the garment image 604 depicts the garment in a flattened condition. For example, the garment image 604 may depict the garment unfolded on a flat surface such as a table so that the edges of the garment are shown. In some instances, the garment image 604 may be the subject image 118. For example, the subject image 118 depicts the individual as described above, and the subject image 118 may be processed by the garment similarity module 602 using the CNN 608 to determine other garments that are similar to the garments worn by the individual. As one example, the subject image 118 may depict the individual wearing a t-shirt and shorts, and the garment similarity module 602 may determine other t-shirts and other shorts that are similar to, or the same as, those worn by the individual. The similar garments may then be presented as described above.

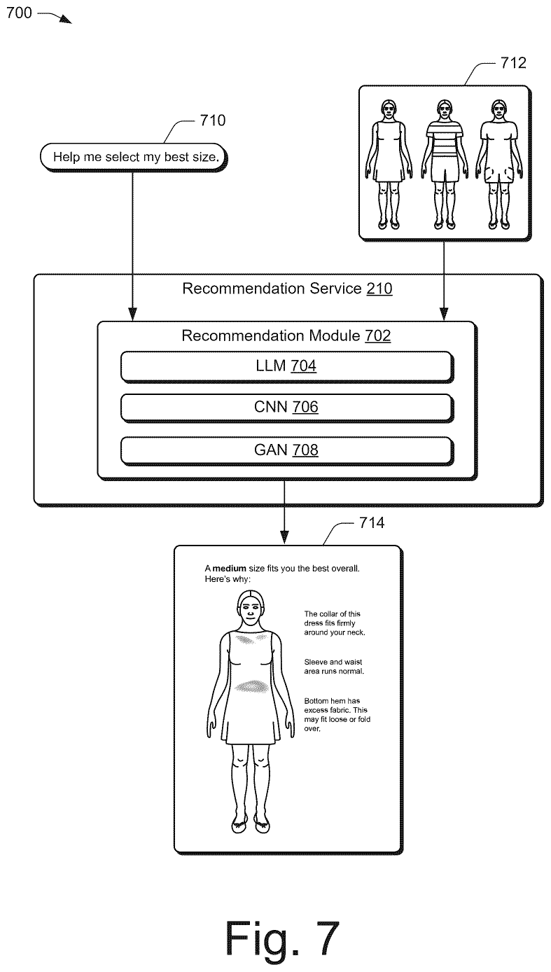

FIG. 7 depicts a system 700 in an example implementation showing the operation of the recommendation service 210 of the remote provider system 102 of FIG. 1 in greater detail. The recommendation service 210 is configurable to implement a pipeline to address technical challenges, supporting generation of recommendations for garments, garment size recommendations, outfit recommendations, and more. To do so, the recommendation service 210 employs a recommendation module 702 that includes, in this example, an LLM 704, a CNN 706, and a GAN 708.

The recommendation module 702 is configured to receive natural language input 710 and user and wardrobe data 712. The user and wardrobe data 712 may include a variety of information associated with a user navigating the user interface implemented by the try-on management service 114, as well as other information relating to garments known to the try-on management service 114. For example, the user and wardrobe data 712 may include information describing measurements of the user (e.g., as determined using the garment fit service 216), garments that have been presented during navigation of the user interface, garments purchased by the user, outfits that have been generated (e.g., using the garment layering service 214), representations of an individual that have been generated (e.g., using the image touch-up service 202, background service 204, pose transfer service 218, garment layering service 214, etc.), heat maps that have been generated (e.g., using the garment fit service 216), garments that have been scanned (e.g., using the garment scanning service 208), poses that have been selected (e.g., using the pose transfer service 218), backgrounds that have been selected or generated (e.g., using the background service 204), natural language input that has been input (e.g., for prior generation of recommendations), garment data available to the try-on management service 114 (e.g., pre-defined garment data 606), and so forth.

The LLM 704 processes natural language input 710 and determines a context of the content of the natural language input 710. Determining the context includes, for example, determining objects, environments, a meaning of queries and/or statements, and/or other aspects described by the natural language input 412. Based on the context of the natural language input 710, the recommendation service 210 generates a recommendation 714.

The recommendation module 702 may employ the CNN 706 and/or the GAN 708 for generation of at least a portion of the recommendation 714. For example, based on the content of the natural language input 710, the LLM 704 may be employed to provide a textual portion of the recommendation 714 (e.g., an explanation in words or sentences to a query described in the natural language input 710) and the CNN 706 may be employed to provide a portion of the recommendation 714 based on an analysis of the user and wardrobe data 712 (e.g., a comparison of garments, trends identified in garments viewed by the user and/or owned by the user, etc.).

In some instances, the recommendation module 702 employs the GAN 708 to generate one or more images to be included in the recommendation 714. For example, the GAN 708 may be employed to generate graphics, charts, and so forth. In an example in which the natural language input 710 includes a statement such as “show me a table ranking garments by best fit,” the GAN 708 may be employed to generate an image showing the table. In another example in which the natural language input 710 includes a statement such as “show me a picture of all garments I have purchased, organized by color,” the GAN 708 may be employed to generate an image showing the garments organized by color.

In some instances, the recommendation module 702 may employ one or more of the services described herein to provide and/or generate content for the recommendation 714. As an example, the natural language input 710 may include a statement such as “how would I look in a red dress?” Responsive to processing the natural language input 710, the recommendation module 702 can employ the garment fit service 216 to generate a representation of the user wearing a red dress, with the representation included in the recommendation 714. In some instances, the recommendation 714 can include a link for purchase of the dress and/or addition of the dress to the try-on wardrobe interface 506. In some instances, the recommendation service 210 can employ the garment scanning service 208 to determine other garments similar to the dress (e.g., using the garment similarity module 602). Other examples are possible.

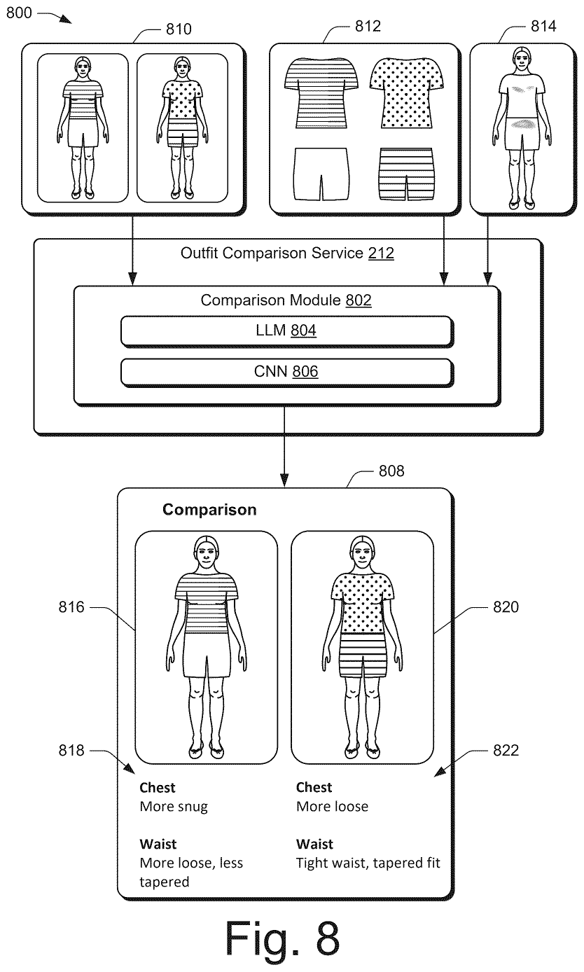

FIG. 8 depicts a system 800 in an example implementation showing the operation of the outfit comparison service 212 of the remote provider system 102 of FIG. 1 in greater detail. The outfit comparison service 212 is configurable to implement a pipeline to address technical challenges, supporting comparisons of outfits. Such comparisons can include presentation of different outfits concurrently as well as information describing the relative fit of each outfit. In particular, the information describing the relative fit includes information relating the fit of garments of one outfit to the fit of garments of another outfit. To do so, the outfit comparison service 212 employs a comparison module 802 implementing an LLM 804 and a CNN 806.

The comparison module 802 receives various information as input and outputs a comparison 808 describing two or more outfits relative to each other. In the depicted example, the comparison module 802 receives outfit selections 810, garment data 812, and fit data 814. The garment data 812 describes garments included by the outfits of the outfit selections 810 (e.g., shorts, shirts, and so forth). The fit data 814 describes the fit of the garments included by the outfits of the outfit selections 810 while worn by the individual depicted in the subject image 118. The fit data 814 may be generated by the garment fit service 216 and provided to the comparison module 802.

The comparison module 802 may employ the CNN 806 for comparing fit data 814 associated with each outfit of the outfit selections 810. For example, a first outfit of the outfit selections 810 may be associated with a first set of information in the fit data 814, and a second outfit of the outfit selections 810 may be associated with a second set of information in the fit data 814. The CNN 806 can compare the first set of information to the second set of information and determine similarities and differences between the fit of the first outfit compared to the fit of the second outfit.

The comparison module 802 may employ the LLM 804 to generate a description (e.g., natural language words and/or sentences) describing the relative fit of the outfits of the outfit selections 810 (e.g., similarities and differences between the fit of the first outfit compared to the fit of the second outfit). As an example, the comparison module 802 may employ the CNN 806 to compare the fit data 814 associated with each outfit of the outfit selections 810 as described above. Based on the comparison, the comparison module 802 may employ the LLM 804 to generate the description.

In the example shown, the comparison 808 depicts a first outfit 816 associated with a first description portion 818 and a second outfit 820 associated with a second description portion 822. The first description portion 818 describes the fit of the garments of the first outfit 816 relative to the second outfit 820. The second description portion 822 describes the fit of the garments of the second outfit 820 relative to the first outfit 816. The comparison 808 thus provides a variety of information that may not be available in situations in which garments or outfits are viewed individually.

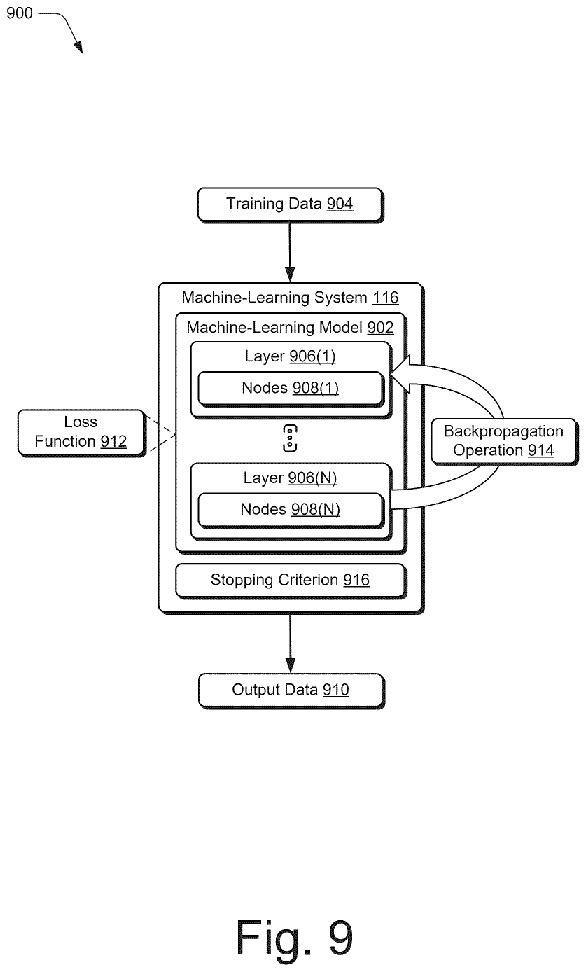

FIG. 9 depicts a system and procedure in an example implementation 900 for training a machine-learning model 902 as part of the machine-learning system 116 of FIG. 1. The machine-learning model 902 is illustrated as implemented as part of the machine-learning system 116. The machine-learning system 116 is representative of functionality to generate training data 904, use the generated training data 904 to train the machine-learning model 902, and/or use the trained machine-learning model 902 as implementing the functionality described herein.

A “machine-learning model” refers to a tunable computer representation (e.g., through training and retraining) based on inputs without being actively programmed by a user to approximate unknown functions, automatically and without user intervention. In particular, the term machine-learning model includes a model that utilizes algorithms to learn from and make predictions on known data by analyzing training data to learn and relearn to generate outputs that reflect patterns and attributes of the training data. Examples of machine-learning models include neural networks, CNNs, long short-term memory (LSTM) neural networks, GANs, decision trees, support vector machines, linear regression, logistic regression, Bayesian networks, random forest learning, dimensionality reduction algorithms, boosting algorithms, deep learning neural networks, etc.

In this context, the machine-learning model 902 employs a diffusion model. A “diffusion model” is a generative machine-learning model for digital content creation (e.g., output image 416). To train the diffusion model, noise is added to training data samples until the data within the training data samples is obscured. The diffusion model is then trained self-supervised to reverse this process based on training data with a text prompt describing the digital content to be created to generate data samples as the digital content corresponding to the text prompt. To train the diffusion model, the underlying machine-learning model 902 is provided with the training data 904 that includes examples of images to train and retrain the model to predict the image to be generated.

In some implementations, the machine-learning model 902 also employs a parametric model. A parametric model uses a fixed number of parameters to represent the data (e.g., mesh models) it describes. In other words, these parameters act as the knobs turned to adjust the model's fit to the data. Parametric models use a finite or predetermined set of parameters. Because they have a fixed number of parameters, parametric models are often simpler to train and require less data than non-parametric models.

In the illustrated example, the machine-learning model 902 is configured using a plurality of layers 906(1), . . . , 906(N) having, respectively, a plurality of nodes 908(1), . . . , 908(N). The plurality of layers 906(1)-906(N) are configurable to include an input layer, an output layer, and one or more hidden layers. Calculations are performed by the nodes 908(1)-908(N) within the layers via hidden states through a system of weighted connections that are “learned” during training to implement a variety of tasks (e.g., caption generation).

To train the machine-learning model 902, the training data 904 is received that provides examples of “what is to be learned” by the machine-learning model 902, i.e., as a basis to learn patterns from the data. The machine-learning model 902, for instance, collects and preprocesses the training data 904 that includes input features and corresponding target labels, i.e., of what is exhibited by the input features. The machine-learning system 116 then initializes the parameters of the machine-learning model 902, which the machine-learning system 116 uses as internal variables to represent and process information during training and represent interferences gained through training. In an implementation, the training data 904 is separated into batches to improve the processing and optimization efficiency of the parameters during training.

The training data 904 is then received as input and used to generate predictions based on the current state of parameters of layers 906(1)-906(N) and corresponding nodes 908(1)-908(N) of the model. The machine-learning model 902 outputs its result as output data 910. The output data 910 describes an outcome of the task (e.g., generating a pose-transferred image).

Training the machine-learning model 902 includes calculating a loss function 912 to quantify a loss associated with operations performed by nodes 908(1)-908(N) of the machine-learning model 902. For instance, calculating the loss function 912 includes comparing a difference between predictions specified in the output data 910 with target labels specified by the training data 904. The loss function 912 is configurable in various ways, including regression, the quadratic loss function as part of a least squares technique, and so forth.

Calculating the loss function 912 also includes using a backpropagation operation 914 to minimize the loss function 912, thereby training the parameters of the machine-learning model 902. Minimizing the loss function 912 includes adjusting the weights of the nodes 908(1)-908(N) to minimize the loss and thereby optimize the performance of the machine-learning model 902 for a particular task. The adjustment is determined by computing a gradient of the loss function 912, which indicates a direction to be used to adjust the parameters for minimizing the loss. The parameters of the machine-learning model 902 are then updated based on the computed gradient.

This process continues over several iterations until a stopping criterion 916 is met. The stopping criterion 916 is employed by the machine-learning system 116 in this example to reduce overfitting of the machine-learning model 902, reduce computational resource consumption, and promote an ability to address previously unseen data, i.e., that is not included specifically as an example in the training data 904. Examples of the stopping criterion 916 include but are not limited to a predefined number of epochs, validation loss stabilization, achievement of a performance improvement threshold, or based on performance metrics such as precision and recall.

FIGS. 10 through 35 depict an example user interface 1000 to employ the remote try-on wardrobe management and customization techniques described herein. The user interface 1000 can be presented by a display such as the display 106 of the computer 104 in FIG. 1. The user interface 1000 can receive input from a user via one or more user interface devices, such as a keyboard, mouse, trackpad, microphone, and so forth.

In FIGS. 10 through 12, the user interface 1000 shows a menu 1002 for subject image feature adjustment. In FIG. 10, the subject image 118 represents a subject person 1004 (e.g., online purchaser) wearing a first upper garment and a first lower garment owned by the subject (e.g., physically present with the subject). The subject uploads or selects the subject image 118 from memory associated with the user's electronic device or the clothing application. In one implementation, the subject image 118 includes a front view of the subject, but different-facing views are provided in different implementations.

FIG. 10 shows the subject person 1004 depicted by the subject image 118. The subject image 118 is provided to the try-on management service 114 of the remote provider system 102. For instance, the subject image 118 can be uploaded to the remote provider system 102 from a computing device such as the computer 104 over the network 110 (e.g., the Internet). In some instances, the subject image 118 can be retrieved by the remote provider system 102 from a location accessible to the remote provider system 102 over a network such as the Internet (e.g., retrieved from cloud storage).

In this example, the first upper garment is a t-shirt 1006, and the first lower garment is a pair of shorts 1008. However, the techniques described herein are not limited by the garments worn by the subject person 1004 in the subject image 118, and in some instances the subject image 118 can depict the subject person 1004 wearing different garments. For example, the subject image 118 may be a digital photograph of a user acquired by way of a smartphone camera or other imaging device, with the digital photograph depicting the user wearing any type of garment.

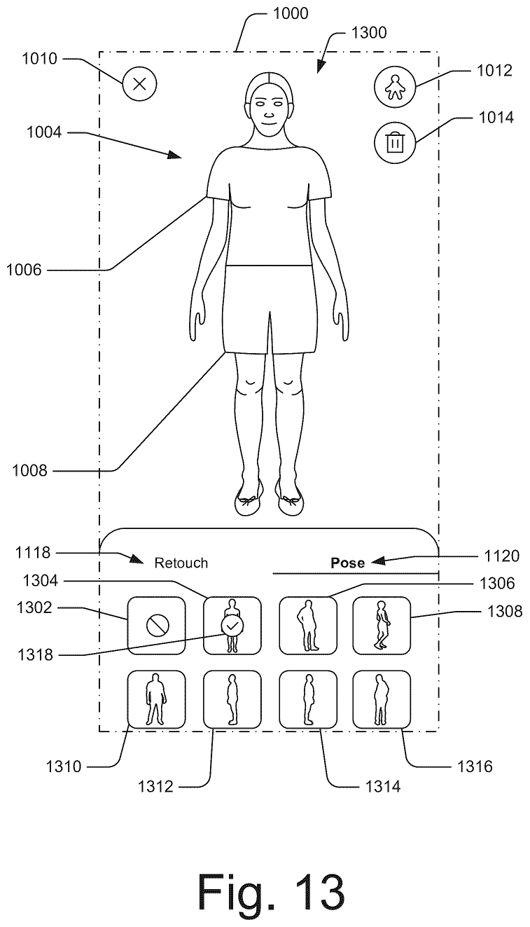

The user interface 1000 includes various elements that can be interacted with by way of user input to perform operations relating to the menu 1002 and the other menus described herein. For instance, in FIGS. 10 through 12, the user interface 1000 displays a cancel button 1010, a navigation button 1012, and a discard button 1014. User input can be applied by way of a user input device such as a mouse, keyboard, trackpad, etc. to control operation of the user interface 1000. For example, user input applied to select the cancel button 1010 may cause the user interface 1000 to transition away from displaying the menu 1002 (e.g., display a different menu, such as a previously viewed menu). User input applied to select the discard button 1014 may discard the subject image 118 provided to the try-on management service 114, e.g., for upload or retrieval of a different subject image. User input applied to the navigation button 1012 may cause the user interface 1000 to display options for selecting various other menus for display, such as the menus described below with reference to FIGS. 13 through 35.

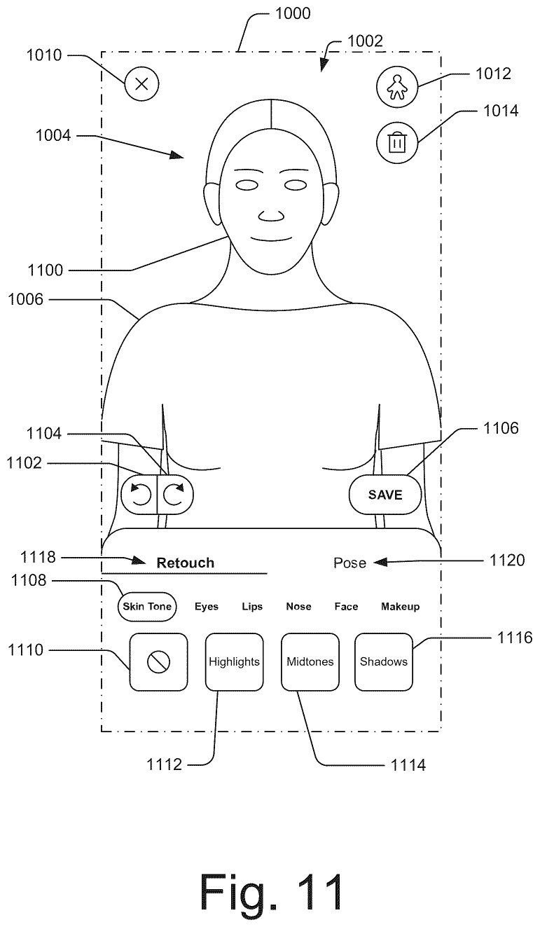

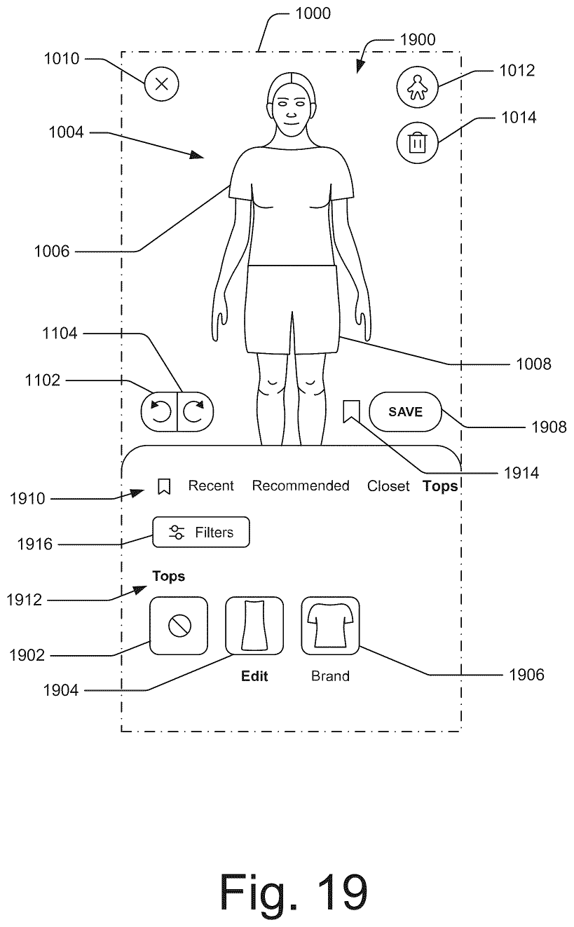

The menu 1002 includes a view try-on button 1016 and an edit photo button 1018. Selection of the view try-on button 1016 via user input causes the user interface 1000 to transition to displaying a menu for virtual garment try-on, as described further below with reference to FIGS. 19-22. Selection of the edit photo button 1018 causes the user interface 1000 to transition to displaying another section of the menu 1002 as depicted by FIG. 11.

In FIG. 11, the menu 1002 displays an enlarged view of the subject person 1004 from the subject image 118 depicting a face 1100 of the subject person 1004 in greater detail. The section of the menu 1002 depicted by FIG. 11 may be displayed responsive to selection of the edit photo button 1018 in the section displayed by FIG. 10, as described above.

In the example depicted by FIG. 11, the depicted section of the menu 1002 also includes various elements that can be interacted with by way of user input to perform various operations. In particular, the menu 1002 shows an undo button 1102, a redo button 1104, and a save button 1106. Selection of the undo button 1102 may reverse a most recently applied adjustment to the depiction of the subject person 1004 (e.g., adjustments to skin tone, cosmetics, and so forth as described below). Selection of the redo button may re-apply an adjustment reversed by way of the undo button 1102. The save button 1106 may save the selected adjustments as a preset, e.g., for application of the same adjustments to another subject image. Presets may be accessible for selection in some instances by way of a presets submenu.

The menu 1002 additionally shows a retouch selector 1108, a blank retouch indicator 1110, a highlights retouch indicator 1112, a midtones retouch indicator 1114, and a shadows retouch indicator 1116. The retouch selector 1108 indicates the category of retouch options that is currently selected. In the depicted example, the retouch options include “skin tone,” “eyes,” “lips,” “nose,” “face,” and “makeup.” In some instances, the retouch options may additionally include a “presets” option used to access the presets submenu described above and/or other options. The menu 1002 further shows a retouch section indicator 1118 and a pose selection indicator 1120. In the depicted example the retouch section of the menu 1002 is displayed, as indicated by the bold text and underline of the retouch section indicator 1118.

The blank retouch indicator 1110 may be selected by way of user input to remove adjustments to the appearance of the subject person 1004 that are associated with the currently selected category of retouch options. For example, selection of the blank retouch indicator 1110 may remove adjustments to the skin tone of the subject person 1004. The highlights retouch indicator 1112, the midtones retouch indicator 1114, and the shadows retouch indicator 1116 may be selected to adjust the highlights, the midtones, and the shadows, respectively, of the skin tone in the depiction of the subject person 1004. Adjustment of the highlights, the midtones, and the shadows may include entering a numerical value to increase or decrease the contrast of these features, sliding one or more slider bars of the menu 1002 to increase or decrease the contrast, and so forth.

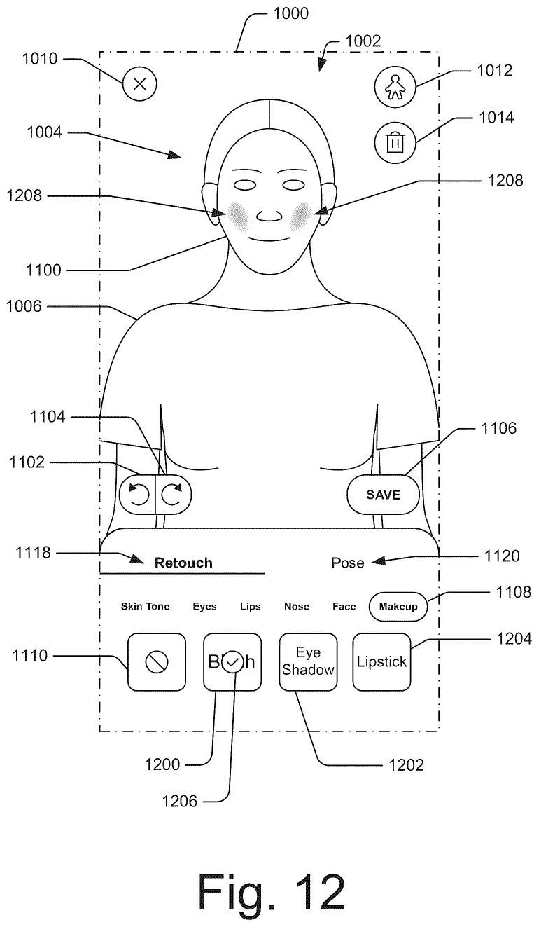

In FIG. 12, the subject person 1004 is depicted with an adjustment applied to cosmetics at the face 1100 of the subject person 1004. In particular, the “makeup” retouch option is selected as indicated by the retouch selector 1108 encircling the “makeup” retouch option. The selection of the “makeup” retouch option causes the display of a blush retouch indicator 1200, an eye shadow retouch indicator 1202, and a lipstick retouch indicator 1204. In the depicted example, the blush retouch indicator 1200 has been selected as indicated by a selection indicator 1206 overlaying the blush retouch indicator 1200.

The selection of the blush retouch indicator 1200 causes the try-on management service 114 to employ the image touch-up service 202 adjust the appearance of the depiction of the subject person 1004 as presented in the user interface 1000. In the example shown, the appearance of the subject person 1004 is adjusted by the try-on management service 114 via the image touch-up service 202 to include blush at the cheeks of the face 1100 as indicated by shaded portions 1208. The adjusted appearance of the depiction of the subject person 1004 can be saved (e.g., stored to memory of the remote provider system 102, cloud storage, etc.) by way of user input applied to the save button 1106. For example, responsive to selection of the save button 1106, the try-on management service 114 may store the depiction of the subject person 1004 adjusted to include the blush as an additional subject image that can be utilized for the techniques described herein. As one example, the adjusted depiction of the subject person 1004 can be used as a subject image for pose transfer, garment try-on, background selection, and so forth.

FIGS. 13 through 15 depict the user interface 1000 showing a menu 1300 for pose selection. The menu 1300 may be a section of the menu 1002 described above. FIG. 13 shows the subject person 1004 depicted by the subject image 118 wearing the t-shirt 1006 and the shorts 1008 as described above. The menu 1300 may be displayed by the try-on management service 114 responsive to selection of the pose selection indicator 1120 in the example described above with reference to FIGS. 10 through 12. In the example depicted by FIG. 13, the menu 1300 shows a blank pose indicator 1302. Selection of the blank pose indicator 1302 causes the subject person 1004 to be depicted without pose transfer. For example, while the blank pose indicator 1302 is selected, the pose of the subject person 1004 as displayed in the menu 1300 may be the same as the pose of the subject person 1004 in the subject image 118.

The menu 1300 further shows a first pose indicator 1304, a second pose indicator 1306, a third pose indicator 1308, a fourth pose indicator 1310, a fifth pose indicator 1312, a sixth pose indicator 1314, and a seventh pose indicator 1316. Although seven pose indicators are shown in this example, in other instances the number of pose indicators may be different. Each pose indicator is associated with a corresponding pose, and selection of one of the pose indicators causes the try-on management service 114 to present a depiction of the subject person 1004 in the pose associated with the selected pose indicator. Additionally, the selected pose indicator is shown overlaid by a pose selection indicator 1318.

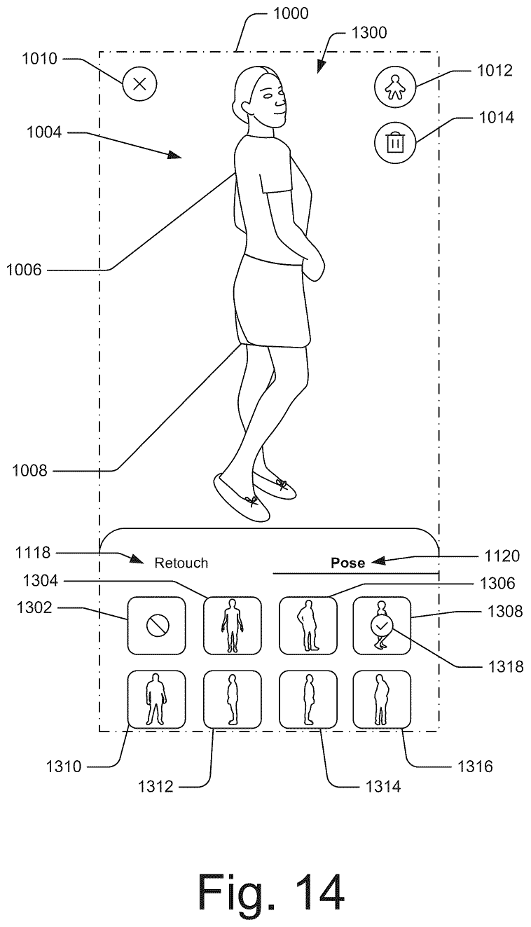

As an example, in FIG. 14, the third pose indicator 1308 has been selected as indicated by the pose selection indicator 1318 overlaying the third pose indicator 1308. Responsive to the selection, the try-on management service 114 employs the pose transfer service 218 to determine (e.g., generate) a representation of the subject person 1004 in the pose associated with the third pose indicator 1308. In this instance, the representation depicts the subject person 1004 in a pose in which a right side of the subject person 1004 faces the plane of view. In the example shown, each pose indicator includes a respective silhouette showing the associated pose. In some instances, the pose indicators may describe the poses using words (e.g., natural language), mannequins, and/or other information.

The representations of the subject person 1004 in the poses associated with the pose indicators as displayed by the menu 1300 can be used as subject images for other operations performed by the try-on management service 114. For example, the depicted image of the subject person 1004 in the pose associated with the third pose indicator 1308 can be used by the try-on management service 114 for garment try-on operations (e.g., employing the garment layering service 214), image touch-up operations (e.g., as described above with reference to FIGS. 10 through 12), background selection operations (e.g., employing the background service 204), and so forth. Further, depictions of the subject person resulting from such operations can be used as input for the described pose transfer operations using the menu 1300.

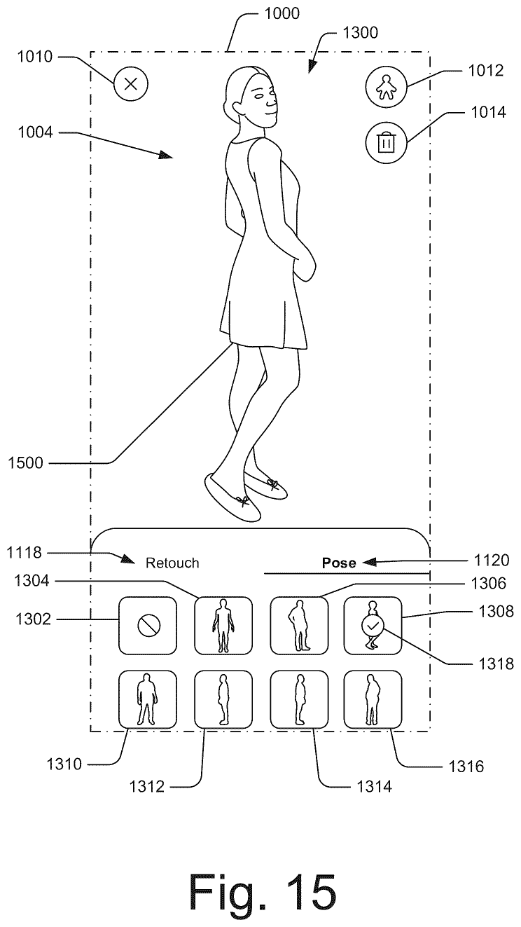

As one example, in FIG. 15, the subject person 1004 is depicted in the pose associated with the third pose indicator 1308. However, in the depicted example, instead of wearing the t-shirt 1006 and the shorts 1008 as in the example shown by FIG. 14, the subject person is shown wearing a dress 1500. In one instance, the depiction of the subject person shown in the example of FIG. 15 can result from providing the try-on management service 114 with a subject image depicting the subject person wearing the dress 1500. The third pose indicator 1308 may then be selected to present a representation of the subject person wearing the dress 1500 in the pose associated with the third pose indicator 1308. In another instance, the try-on management service 114 may be provided a subject image of the subject person wearing garments that are different than the dress 1500 (e.g., the t-shirt 1006 and the shorts 1008). The third pose indicator 1308 can be selected to present a representation of the subject person wearing the different garments in the pose associated with the third pose indicator 1308. The representation can then be used as a subject image for garment try-on as described below, with selection of the dress 1500 during try-on resulting in the depiction of the subject person shown by FIG. 15.

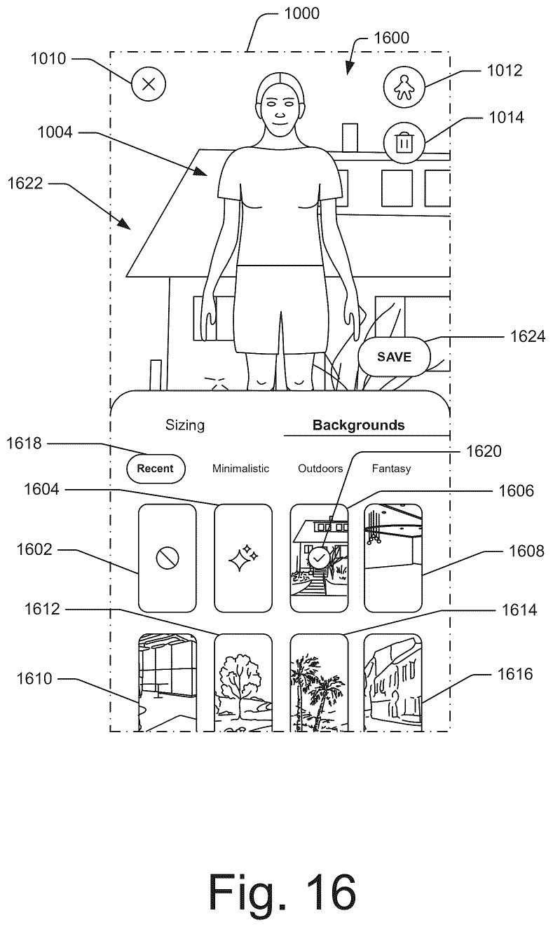

FIGS. 16 through 18 depict the user interface 1000 showing a menu 1600 for background selection. In particular, the menu 1600 is employed for adjusting the appearance of background elements in the representations of the subject person shown by the user interface 1000. For example, the background selection may be used to replace a portion or an entirety of a background depicted in a subject image provided to the try-on management service 114.

In FIG. 16, the menu 1600 is depicted showing a plurality of background indicators that are selectable for adjusting the background in the depicted representation of the subject person. In particular, the menu 1600 is shown including a blank background indicator 1602, a background generation indicator 1604, a residential background indicator 1606, a first interior background indicator 1608, a second interior background indicator 1610, a first landscape background indicator 1612, a second landscape background indicator 1614, and a city background indicator 1616. The backgrounds associated with the background indicators are non-limiting examples of backgrounds that may be selected for presentation with the representation of the subject person, and other types of backgrounds are possible.

In the example shown, the menu 1600 further includes a background type selection indicator 1618 which indicates the types of backgrounds that are shown for selection via the background indicators. For example, each background may be associated with corresponding metadata describing a type or category of the background, such as “recent,” “minimalistic,” “outdoors,” “fantasy,” and so forth. Selection of one of the categories of backgrounds replaces the depicted background indicators with background indicators associate with the selected category.

The menu 1600 further depicts a background selection indicator 1620 which indicates the currently selected background. In the depicted example, the residential background indicator 1606 is selected, resulting in presentation of the associated background (e.g., a scene 1622 with a house) behind the representation of the subject person in the menu 1600. The image of the subject person overlaying the selected background can be saved (e.g., stored to memory of the remote provider system 102, stored to cloud storage, etc.) by way of selection of a save button 1624. The saved image can then be used for other operations by the try-on management service 114 in accordance with the described techniques, such as garment try-on, image touch-up, and so forth.

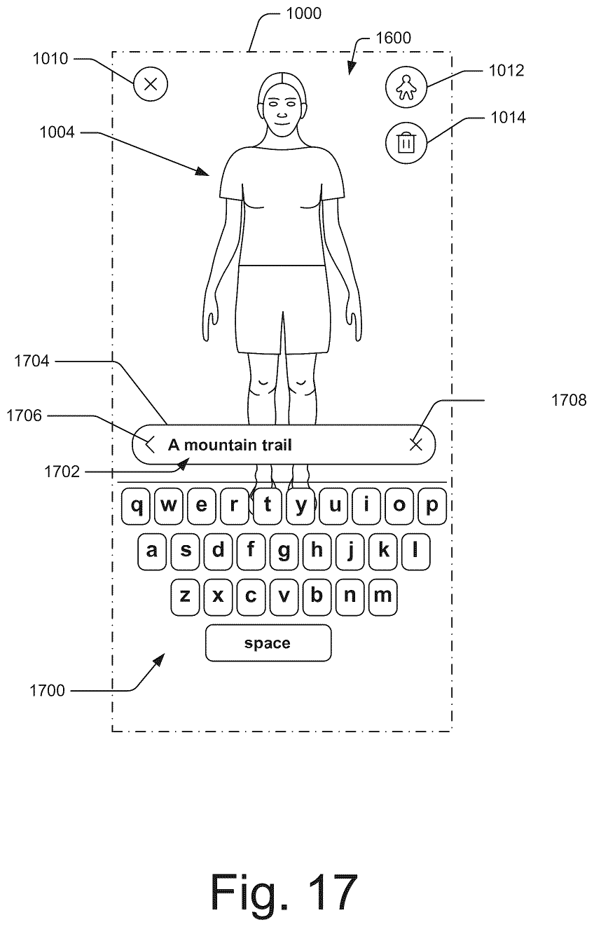

In FIG. 17, a section of the menu 1600 is depicted that is operable for generation of custom backgrounds. Custom backgrounds include, for example, backgrounds that are not pre-defined by the remote provider system 102. The custom backgrounds can be generated by the try-on management service 114 via the background service 204 responsive to user input to the menu 1600.

The menu 1600 is shown including a graphical representation of a keyboard, which is referred to herein as a graphical keyboard 1700. The graphical keyboard 1700 may be displayed, for example, in implementations in which the menu 1600 is displayed on a touch-sensitive display (e.g., a touchscreen of a smartphone, tablet, etc.). Input applied to the graphical keyboard 1700 (e.g., touching of the keys of the graphical keyboard 1700) can be used for providing natural language input 1702 to a natural language entry field 1704 of the menu 1600. In some instances, a physical keyboard or other user interface device may be used to provide the natural language input 1702. The menu 1600 additionally includes a return icon 1706 that can be selected to return to the section of the menu 1600 depicted by FIG. 16, and a clear icon 1708 that can be selected to clear the natural language entry field 1704 (e.g., remove the natural language input 1702).

Further, in some instances, the natural language input 1702 may be input by way of audio input to a microphone or other device configured to receive audio as input. For example, a user may speak into a microphone, and the spoken words may be converted to natural language text in the natural language entry field 1704 using an audio-to-text machine-learning model.

In an example operation, a user inputs the natural language input 1702 to the natural language entry field 1704. In this example, the natural language input 1702 describes a scene including a mountain trail. However, this example is non-limiting, and other scenes may be described. For instance, the natural language input 1702 may describe an aquatic scene, a forested scene, an indoor scene, or other type of scene. The natural language input 1702 is processed by at least one machine-learning model to generate a custom background in accordance with the scene described by the natural language input 1702. The at least one machine-learning model may include, for instance, a text-to-image machine-learning model employing one or more neural networks, GANs, and so forth for custom background generation.

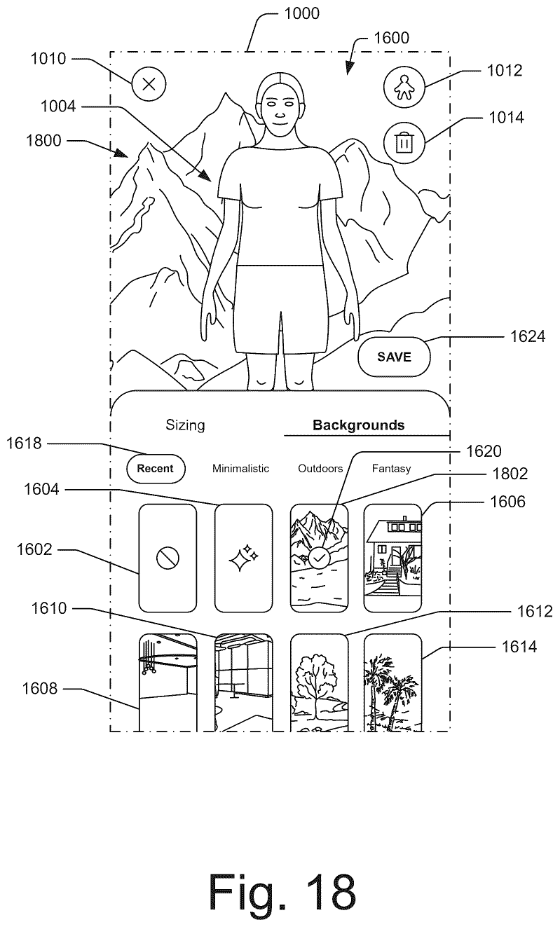

In FIG. 18, the natural language input 1702 described above has been processed by the one or more machine-learning models to generate a mountain background 1800. The representation of the subject person is shown overlaying the mountain background 1800. Additionally, a mountain background indicator 1802 representing the mountain background 1800 is included in the menu 1600. A user may adjust the background depicted with the representation of the subject person by selecting one of the background indicators as described above.

In some instances, responsive to selection of a background indicator to show the subject person overlaying the background, the one or more machine-learning models additionally adjust lighting or other elements in the representation of the subject person based on the selected background. For example, responsive to selecting the mountain background indicator 1802, the one or more machine-learning models may adjust a tone of lighting of the subject person to be cooler (e.g., increase an amount of blue in the lighting) to more convincingly portray the subject person within the mountain scene. As another example, responsive to selecting the mountain background indicator 1802, the one or more machine-learning models may depict additional elements such as environmental weather (e.g., snow, rain, etc.) overlaying the representation of the subject person. The above examples are non-limiting, and other examples are possible.

The representation of the subject person with the selected background can be saved by way of selection of the save button 1624. The saved representation can be used by the try-on management service 114 as a subject image for other operations described herein such as garment try-on, pose transfer, and so forth.

FIGS. 19 through 22 depict the user interface 1000 showing a menu 1900 for garment try-on selection. In FIG. 19, the menu 1900 is shown including various garment indicators. In particular, the menu 1900 is shown including a blank garment indicator 1902, a first upper garment indicator 1904, and a second upper garment indicator 1906. The garment indicators may be selected in order to cause the user interface 1000 to adjust the appearance of the depiction of the subject person. For example, selection of the first upper garment indicator 1904 causes the user interface 1000 to present the subject person wearing the garment associated with the first upper garment indicator 1904. In the depicted example, the garment associated with the first upper garment indicator 1904 is a dress 2000. Selection of the second upper garment indicator causes the user interface 1000 to present the subject person wearing the garment associated with the second upper garment indicator 1906, e.g., a t-shirt. Selection of the blank garment indicator 1902 causes the user interface 1000 to present the subject person wearing the garment(s) that were depicted prior to selection of one of the first upper garment indicator 1904 or second upper garment indicator 1906.

The menu 1900 additionally shows a save button 1908 that can be selected to cause the try-on management service 114 to store the current depiction of the subject person (e.g., wearing the selected garment(s)) for use as a subject image with other operations in accordance with the techniques described herein, such as pose transfer, background selection, etc. Further, the menu 1900 shows garment categories 1910 that can be selected to cause the menu 1900 to display garment indicators associated with garments within the selected category. For example, the menu 1900 is depicted showing a “bookmark” category (indicated by an icon), a “recent” category, a “recommended” category, a “closet” category, and a “tops” category. In the depicted example, the “tops” category is selected as indicated by a selected garment category label 1912. In some instances, garments may be associated with more than one category (e.g., the dress 1500 may be associated with both of the “tops” category and a “bottoms” category). In some instances, a garment may be associated with one or more categories by way of user input. For example, the t-shirt 1006 and the shorts 1008 may be associated with the “bookmark” category responsive to selection of a bookmark icon 1914 while the garments indicators associated with the t-shirt 1006 and the shorts 1008 are selected.

The menu 1900 additionally shows a filters button 1916 that can be selected to filter garments within a particular category (e.g., display garments that meet a selected criteria). For example, within the “tops” category, the filters button 1916 can be selected to specify a color of the garments within the “tops” category to be presented (e.g., red, blue, brown, etc.).

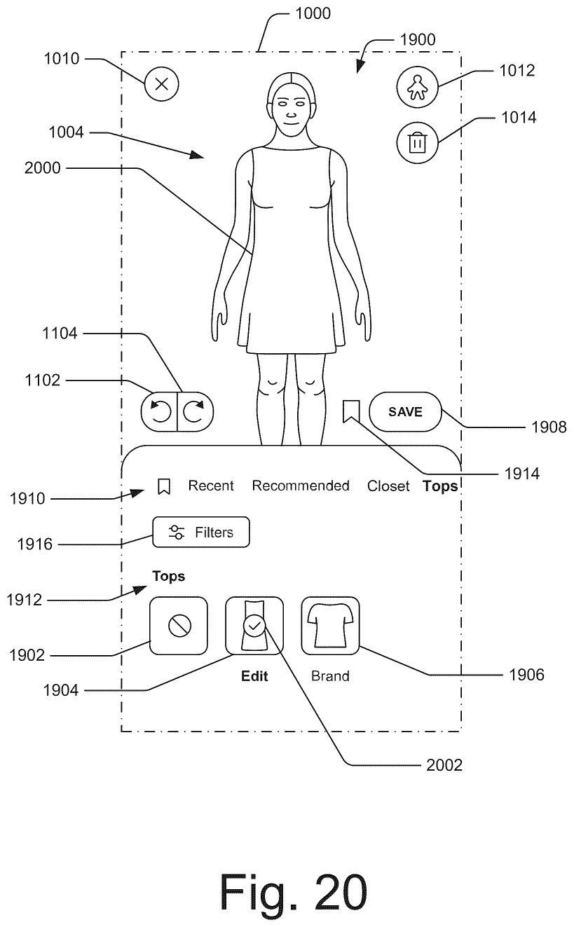

In FIG. 20, the menu 1900 is shown depicting a representation of the subject person in the dress 2000 responsive to selection of the first upper garment indicator 1904 associated with the dress 2000. The selection of the first upper garment indicator 1904 is indicated by a selected garment indicator 2002 overlaying the first upper garment indicator 1904. The representation of the subject person wearing the dress 2000 can be generated via the try-on management service 114 using the garment layering service 214 and/or garment fit service 216 as described above.

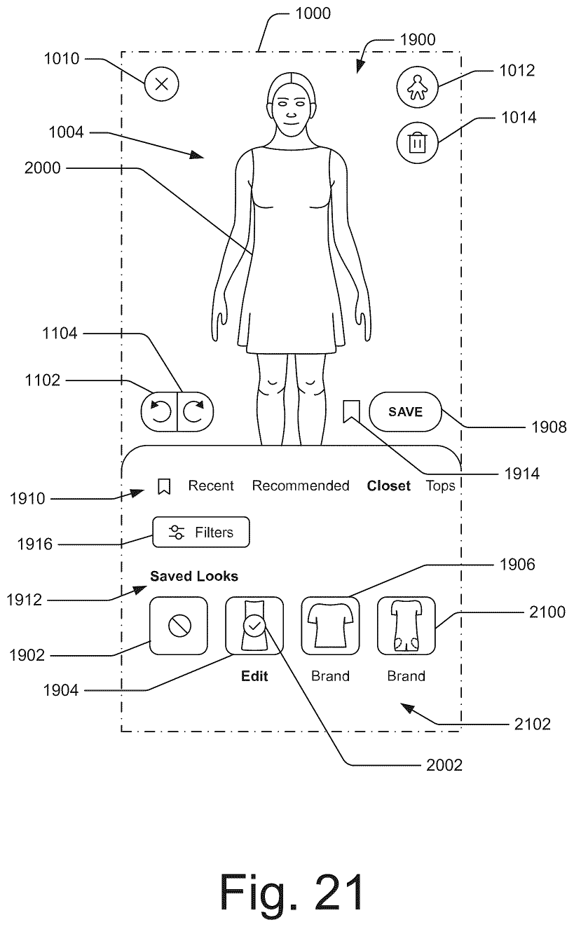

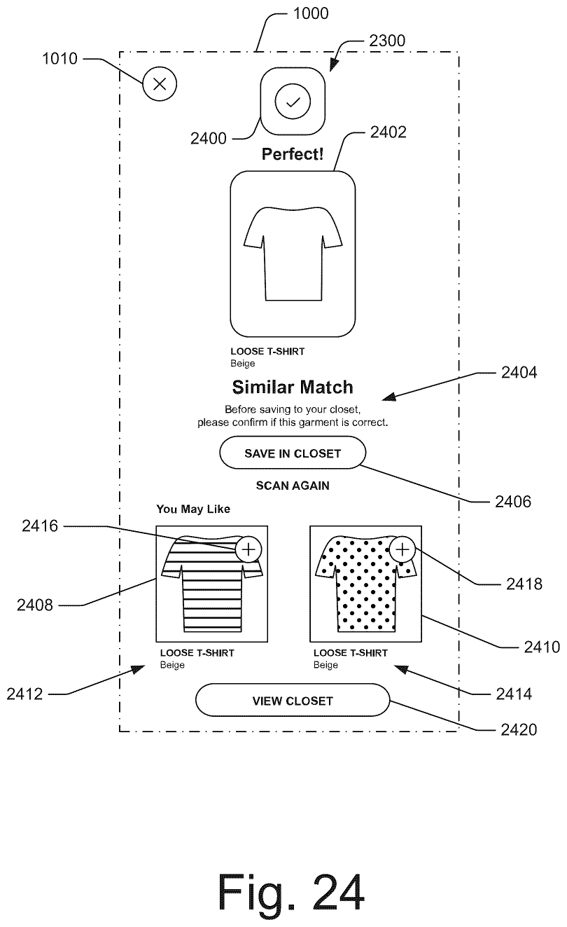

In FIG. 21, the menu 1900 is shown displaying an additional garment indicator, e.g., a third upper garment indicator 2100. The third upper garment indicator 2100 may be displayed responsive to receiving user input via the user interface 1000 to add the garment associated with the third upper garment indicator 2100 to the try-on wardrobe 2102. For example, the garment associated with the third upper garment indicator 2100 may be selected from among a plurality of garments known to the remote provider system 102 by way of user input. The user input can include, for instance, selection of an “add garment” button, similar to the example described further below with reference to FIG. 24.

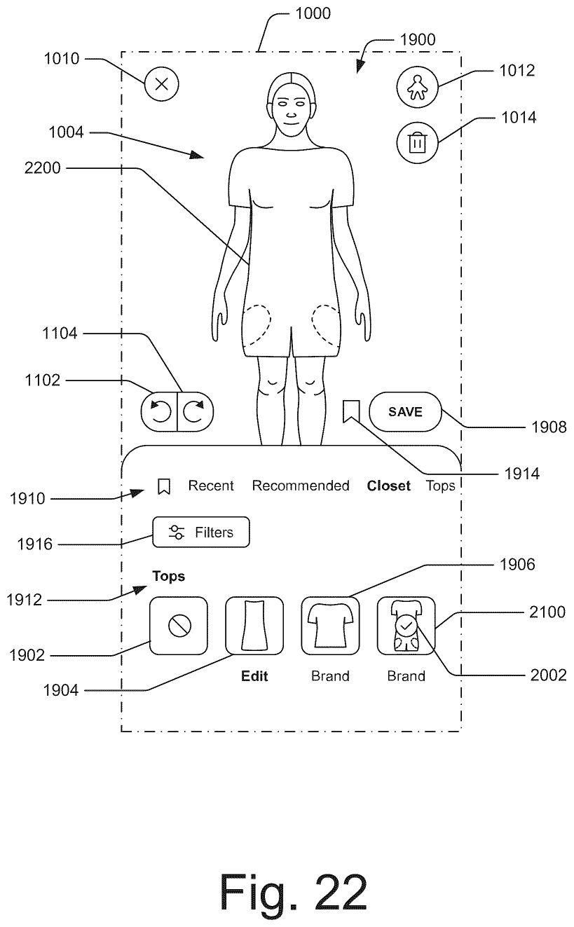

In FIG. 22, the third upper garment indicator 2100 has been selected by way of user input. As a result, the user interface 1000 presents a representation of the subject person wearing the garment associated with the third upper garment indicator 2100. In this example, the garment associated with the third upper garment indicator 2100 is a dress 2200. The representation of the subject person wearing the dress 2200 can be stored for use as a subject image with other operations in accordance with the techniques described herein, such as pose transfer, background selection, etc. by way of selection of the save button 1908.

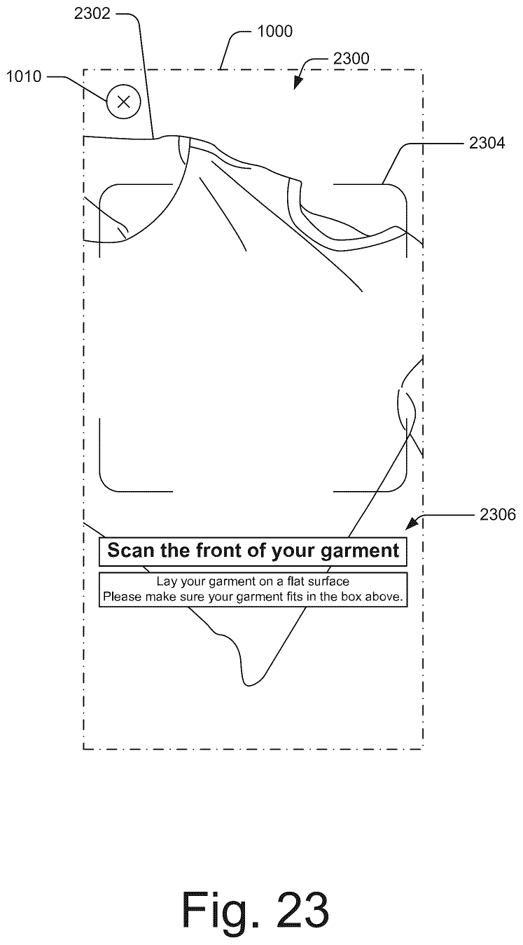

FIGS. 23 and 24 depict the user interface 1000 showing a menu 2300 for garment scanning. The garment scanning is employed by the try-on management service 114 for determining garments known by the remote provider system 102 that are similar to garments processed by way of the garment scanning. For example, a user may provide an image of a garment to the try-on management service 114 using the menu 2300. The try-on management service 114 processes the image of the garment using one or more machine-learning models (e.g., by employing the garment scanning service 208) and determines other garments known to the remote provider system 102 that are similar to the garment depicted in the image. The determined garment(s) can then be added to the try-on wardrobe 2102 for generation of representations of the subject person wearing the garment(s).

In FIG. 23, the menu 2300 is shown with a depiction of an imaged garment 2302. In this example, the imaged garment 2302 is a shirt. In some instances, the depiction of the imaged garment 2302 can be a static image of the imaged garment 2302 uploaded to the remote provider system 102 and provided to the try-on management service 114 (e.g., by way of user input) or retrieved from a location by the remote provider system 102 (e.g., downloaded from a website or other location accessible to the remote provider system 102). In some instances, the depiction of the imaged garment 2302 is acquired substantially in real-time, e.g., via an image sensor (e.g., camera) of a user device such as a smartphone, tablet, webcam, and so forth.

In the example depicted by FIG. 23, the menu 2300 displays an imaging guide 2304 and instructions 2306 for imaging a garment using the menu 2300. In this example, the garment is imaged in substantially real-time as described above and the imaging guide 2304 guides positioning of the image sensor of the user device. As the image sensor is moved (e.g., as the user device is rotated or shifted by a user), the image depicted by the user interface 1000 is updated accordingly based on the subject matter within the field of view of the image sensor.

The try-on management service 114 (via the garment scanning service 208) may employ one or more machine-learning models, such as an image recognition machine-learning model including one or more neural networks, for determining whether the imaged garment (e.g., imaged garment 2302) is depicted sufficiently for processing to determine similarity of the garment with other garments. For example, the one or more machine-learning models may detect whether edges, sleeves, a neckline, and/or other features of the garment are depicted during the imaging. Upon detection of such features, the menu 2300 may transition to another section depicting one or more garments similar to the imaged garment, as described below.

In FIG. 24, the menu 2300 is shown after the imaging of the imaged garment 2302 has been performed as described above. In the section of the menu 2300 depicted by FIG. 24, a confirmation indicator 2400 is displayed to indicate that the imaging of the imaged garment 2302 has been completed. The try-on management service 114 processes the image of the imaged garment 2302 using machine-learning (e.g., via the garment scanning service 208) and determines one or more garments that are similar to the imaged garment 2302 using the one or more machine-learning models. In the depicted example, the try-on management service 114 processes the image of the imaged garment 2302 and determines using the one or more machine-learning models that another garment (referred to as a similar garment 2402) has high similarity to the imaged garment 2302. The similar garment 2402 is presented by the user interface 1000 via the menu 2300. The menu 2300 displays a confirmation prompt 2404, and the similar garment 2402 can be added to the user's try-on wardrobe by way of selection of a confirmation button 2406.

The one or more machine-learning models are trained to identify attributes that are similar between the imaged garment and the other garments known to the remote provider system 102. Such attributes may include, for example, garment shape, garment color, garment pattern, garment material, garment brand, garment price, and so forth.

The similar garment 2402 may be a garment known to the remote provider system 102 that has a high similarity to the imaged garment 2302. For instance, the one or more machine-learning models may generate similarity scores associated with garments known to the remote provider system, where the similarity scores indicate an amount of similarity of the garments to the imaged garment 2302.

The menu 2300 can also present additional garment recommendations based on similarity between the imaged garment 2302 and other garments (e.g., garments different than the similar garment 2402). In the depicted example, the menu 2300 presents a first recommended garment 2408 and a second recommended garment 2410. The menu 2300 additionally displays a description 2412 of the first recommended garment 2408 and a description of the second recommended garment 2414. The first recommended garment 2408 and the second recommended garment 2410 can be saved to the user's try-on wardrobe via a first add garment button 2416 and a second add garment button 2418, respectively. The user interface 1000 can transition from presenting the garment recommendations to displaying the user's try-on wardrobe by way of selection of a view button 2420.

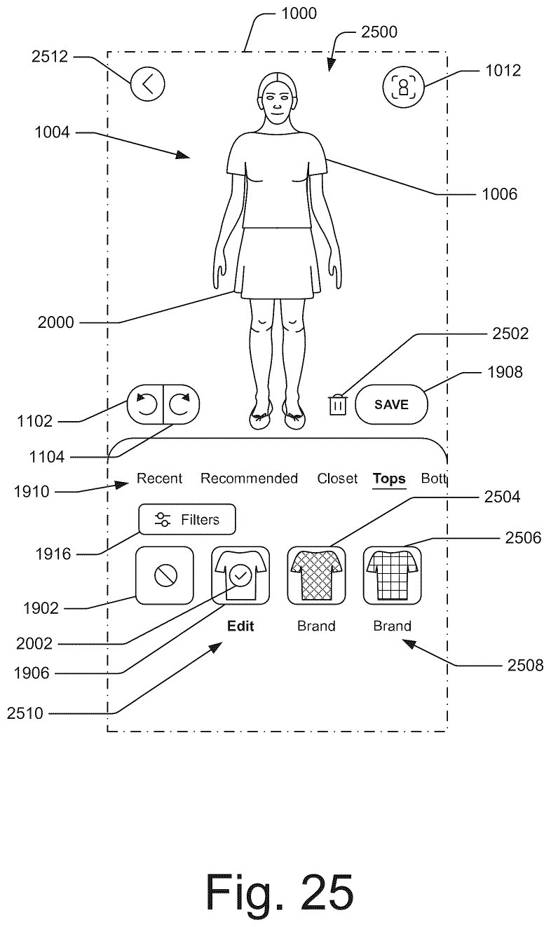

FIGS. 25 through 29 depict the user interface 1000 showing a menu 2500 for garment layering and outfit management. In FIG. 25, the menu 2500 shows a representation of the subject person wearing the t-shirt 1006 layered over the dress 2000. In this example, the representation of the subject person wearing the dress 2000 has been provided as the subject image for try-on of garments in the user's try-on wardrobe. In particular, the t-shirt 1006 has been selected for try-on in this example from among other upper garments (e.g., “tops”), as indicated by the selected garment indicator 2002 overlaying the second upper garment indicator 1906. The try-on management service 114 may layer selected garments over garments already worn by the subject person in the subject image 118 in some instances as depicted. For example, in situations in which the subject person is shown wearing a garment in the subject image 118 that spans both the upper portion of the body of the subject person (e.g., the torso) and the lower portion of the body of the subject person (e.g., the pelvis), the selected garment may be layered over the existing garment worn by the subject person instead of replacing the garment.

The menu 2500 shows a return button 2512 that, when selected, transitions the user interface 1000 to a previously viewed menu (e.g., the most recently viewed menu prior to display of the menu 2500). The menu 2500 additionally shows a discard button 2502 that can be selected to remove the currently selected garment from the representation of the subject person (e.g., revert the representation of the subject person to depict the garments originally worn in the subject image).

The menu 2500 further shows a garment indicator 2504 and a garment indicator 2506 associated with additional garments in the user's try-on wardrobe. The garment indicators have descriptions 2508 providing information relating to the garments represented by the garment indicators 2504 (e.g., a brand, price, size, name, and so forth). In this example, the selected second upper garment indicator 1906 is associated with an edit button 2510 that can be used to specify variations of the garment such as size, color, pattern, etc.

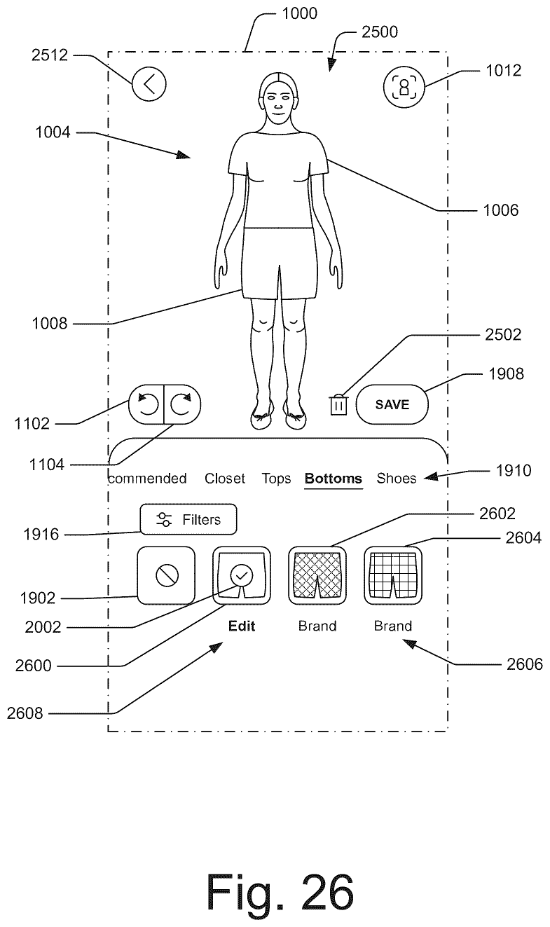

In FIG. 26, the menu 2500 shows a representation of the subject person wearing the t-shirt 1006 layered with the shorts 1008. The shorts 1008 have been selected for try-on in this example from among other lower garments (e.g., “bottoms”), as indicated by the selected garment indicator 2002 overlaying a garment indicator 2600 associated with the shorts 1008. Upon selection of the garment indicator 2600, the try-on management service 114 generates (e.g., via the garment layering service 214) the representation of the subject person wearing the shorts 1008 layered with the t-shirt 1006 previously selected as described above with reference to FIG. 25.

The menu 2500 additionally shows other garments available for try-on, such as different shorts represented by a second garment indicator 2602 and a third garment indicator 2604. The garment indicators are associated with respective descriptions 2606 including information relating to the garments, and variations of the currently selected garment can be selected by way of selection of an edit button 2608 similar to the example described above with reference to FIG. 25.

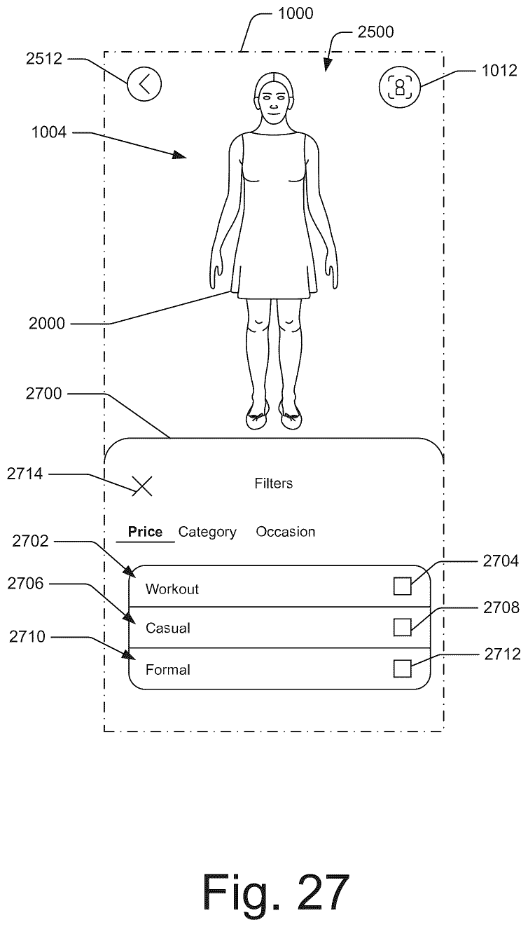

In FIG. 27, a section of the menu 2500 shows a filters panel 2700 including various filter categories that can be selected to filter garments that are presented in the user's try-on wardrobe. Selection of a filter category causes garments within the filter category to be presented while hiding garments that are not within the filter category. In this example, the menu 2500 shows a first filter category 2702 selectable via a first selection box 2704, a second filter category 2706 selectable via a second selection box 2708, and a third filter category 2710 selectable via a third selection box 2712. In some instances, multiple filter categories can be selected concurrently. The menu 2500 also shows a cancel button 2714 that can be used to return to the most recently viewed section of the menu 2500.

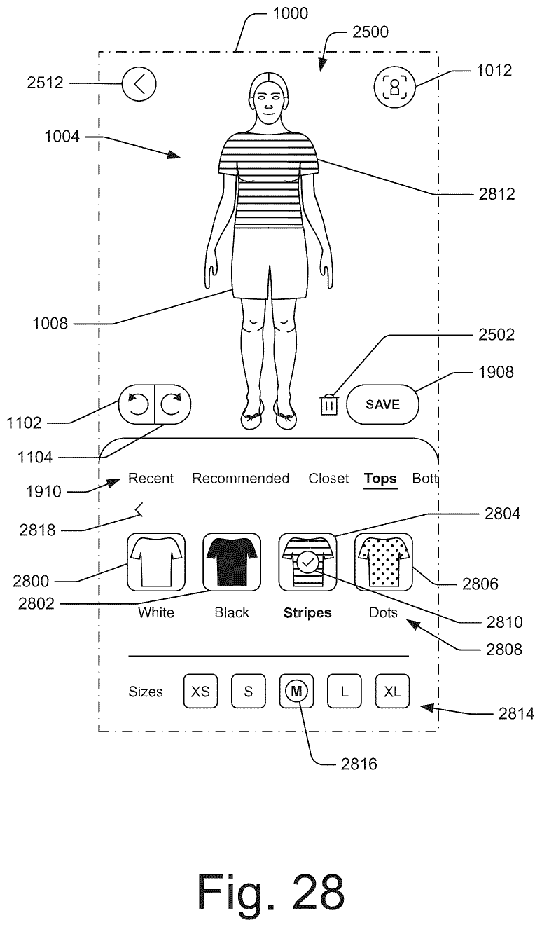

In FIG. 28, a section of the menu 2500 following selection of the edit button 2510 in FIG. 25 is shown. In this section, variations of the t-shirt 1006 available for selection are shown. The variations are known by the remote provider system 102 and are different versions of the t-shirt 1006 that can be used for garment try-on. For example, different colors and/or patterns of the t-shirt 1006 can be selected, as indicated by garment indicator 2800, garment indicator 2802, garment indicator 2804, and garment indicator 2806. Each garment indicator is associated with a respective description 2808 showing information about the garment associated with the corresponding garment indicator. The selected garment version is indicated by a selected garment indicator 2810. In this example, the selected garment is a striped version 2812 of the t-shirt.

Additionally, various sizes 2814 of the garment versions can be selected. Responsive to selection of one of the garment indicators, a representation of the subject person wearing the garment associated with the selected garment indicator is presented. Additionally, responsive to selection of one of the sizes 2814, a representation of the subject person wearing the garment associated with the selected garment indicator in the selected size is presented. The selected size is indicated by a selected size indicator 2816. The representation of the subject person wearing the layered garments in the selected sizes can be stored for use in other operations performed by the try-on management service 114 such as background selection, pose transfer, etc. via selection of the save button 1908. A return button 2818 can be selected to return to the most recently viewed section of the menu 2500.

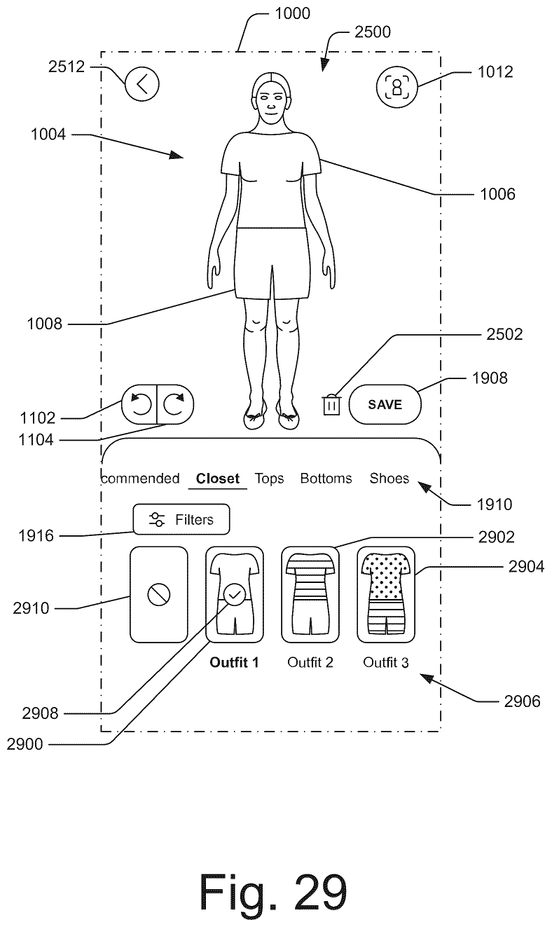

In FIG. 29, a section of the menu 2500 is shown depicting outfits stored to the user's try-on wardrobe. Each outfit specifies one or more garments, and each outfit is associated with a respective outfit indicator displayed in the depicted section of the menu 2500. In this example, the menu 2500 shows a first outfit indicator 2900 associated with a first outfit, a second outfit indicator 2902 associated with a second outfit, and a third outfit indicator 2904 associated with a third outfit. The outfit indicators are associated with respective outfit descriptions 2906. The outfit descriptions 2906 may be names of the outfits (e.g., user-defined names) and/or may include information describing the outfits, such as the garments included by each outfit.

Responsive to selection of one of the outfit indicators, a representation of the subject person wearing the garments specified by the outfit associated with the selected outfit indicator is shown. In the depicted example, the first outfit indicator 2900 is selected as indicated by a selected outfit indicator 2908. The outfit associated with the first outfit indicator 2900 includes the t-shirt 1006 and the shorts 1008. As a result of selection of the first outfit indicator 2900, the representation of the subject person wearing the t-shirt 1006 and the shorts 1008 is presented by the user interface 1000. Further, the garments worn in the representation of the subject person can be adjusted by selecting a different outfit indicator, e.g., the second outfit indicator 2902 or the third outfit indicator 2904.

By supporting selection of the outfits stored to the try-on wardrobe, the user interface 1000 enables quick selection of garments to be depicted as worn in the representation of the subject person. Further, in some instances, the user interface 1000 may support combining multiple outfits to form one or more additional outfits. For example, a user may define a first outfit specifying two garments to be depicted as worn by the subject person (e.g., a shirt and shorts), as well as a second outfit specifying three different garments to be worn by the subject person (e.g., a hat, shoes, and scarf). The user interface 1000 can support combining the first outfit with the second outfit to form a third outfit specifying five garments to be depicted as worn by the subject person, where the five garments include the two garments of the first outfit and the three garments of the second outfit.

The menu 2500 also includes a blank outfit indicator 2910. The blank outfit indicator 2910 can be selected to adjust the representation of the subject person to show the subject person wearing garments that were present prior to selection of one of the outfit indicators.

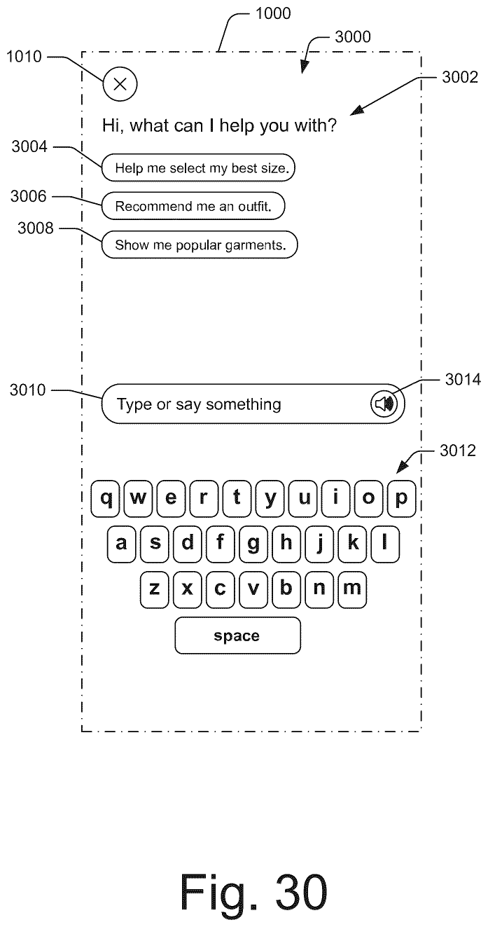

FIGS. 30 through 32 depict the user interface 1000 showing a menu 3000 for natural language input and presentation of recommendations. In FIG. 30, the menu 3000 is shown displaying a prompt 3002 and various suggested inputs for generation of recommendations by the try-on management service 114 (e.g., via the recommendation service 210). In particular, the menu 3000 is shown presenting a first suggested input 3004, a second suggested input 3006, and a third suggested input 3008. In some instances, the suggested inputs may be pre-defined by the try-on management service 114 (e.g., based on requests frequently input by users). In some instances, the suggested inputs may be based on data associated with the particular user navigating the menu 3000. For example, users may be associated with user accounts managed by the remote provider system 102 (e.g., via the try-on management service 114), where each user account includes data such as garments and outfits added to the user's try-on wardrobe, various representations of the subject person wearing garments from the try-on wardrobe, representations of the subject person in poses generated by way of pose transfer as described above, and so forth. The suggested inputs may be based on types of garments stored in the try-on wardrobe of a user account, measurements of the user associated with the user account (e.g., the subject person depicted by the subject image), types of representations of the subject person that have been generated, and so forth.

The menu 3000 further includes a natural language input field 3010 configured to receive natural language input (e.g., words, phrases, sentences, etc.). The natural language input can specify requests, queries, and so forth. The natural language input is processed by at least one machine-learning model, such as a large language model including one or more neural networks. The at least one machine-learning model processes the natural language input and generates recommendations based on a content of the natural language input. The one or more machine-learning models may be trained on data describing various natural language input requests, queries, etc., and outcomes associated with such requests, queries, etc.

The natural language input can be text input using a user interface device, such as a physical keyboard, or a graphical keyboard 3012 displayed by the menu 3000 (e.g., by selecting letters displayed by the graphical keyboard 3012 using a cursor, touchscreen input, etc.). In some instances, the natural language input can be received as audio input (e.g., spoken words) via a device such as a microphone. For example, selection of an audio input button 3014 may cause the microphone to detect audio input. The try-on management service 114 may employ (e.g., via the recommendation service 210) a speech-to-text machine-learning model trained to convert the audio input to text input, with the text input provided to the one or more machine-learning models (e.g., the large language model) for processing to generate recommendations. The one or more machine-learning models employed to generate recommendations determine the content of the natural language input (e.g., using neural network layers) and output responses (e.g., recommendations) based on the content. Selection of one of the suggested inputs causes the text associated with the selected suggested input (e.g., “recommend me an outfit”) to be processed as if the text were entered to the natural language input field 3010.

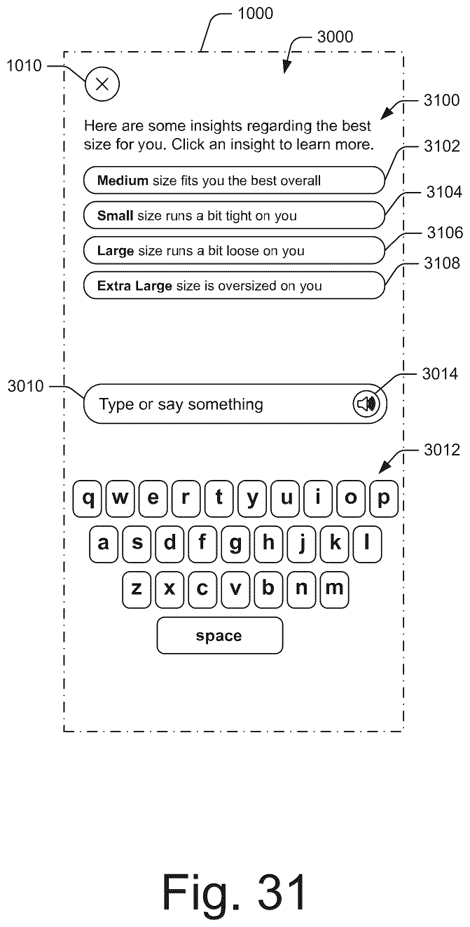

In FIG. 31, a section of the menu 3000 is shown depicting a recommendation 3100 (e.g., an insight) responsive to receiving natural language input as described above with reference to FIG. 30. In this example, the content of the natural language input relates to garment sizing. In particular, the recommendation 3100 displayed by the menu 3000 result from selection of the first suggested input 3004 shown by FIG. 30. In the example, the recommendation 3100 is based on the data associated with the user account of the user navigating the user interface 1000. For instance, the recommendation may be based on a garment selected by the user, the user's measurements, and/or other data. In instances in which a different user selects the first suggested input 3004, the particular recommendations generated may be different than the recommendation 3100 depicted by FIG. 30. Specifically, because the recommendations are based on the data associated with the individual user requesting the recommendations (e.g., data associated with a user account of the user), the recommendations are personalized for each user.

The depicted recommendation 3100 shows various information relating to the sizing inquiry described by the natural language input. In particular, the recommendation 3100 specifies a recommended size for a garment via a first part 3102. The recommendation 3100 additionally indicates how other sizes of the garment are estimated to fit when worn by the subject person via a second part 3104, a third part 3106, and a fourth part 3108. The estimated fit of the different sizes of the garment on the subject person may be based on measurement data (e.g., the subject's measurements extracted via one or more machine-learning models, such as a machine-learning model implemented by the garment fit service 216).

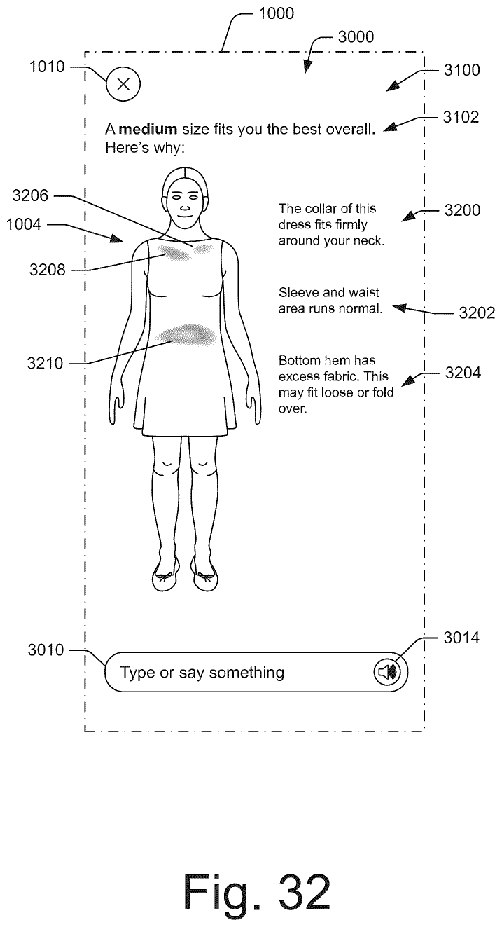

In FIG. 32, a section of the menu 3000 shows additional details included in the recommendation 3100 described above with reference to FIG. 31. In particular, the menu 3000 shows the first part 3102 of the recommendation 3100 (e.g., the recommended size for the garment) along with a first fit detail 3200, a second fit detail 3202, and a third fit detail 3204. The fit details provide additional information relating to the fit of the garment in the recommended size when worn by the subject person.

The menu 3000 additionally shows the subject person overlaid with a heat map indicating the particular fit of the garment when worn by the subject person 1004. The heat map includes various shaded areas, such as a first shaded area 3206, a second shaded area 3208, and a third shaded area 3210. In this example, the shaded areas are shown in grayscale. However, in some instances, the shaded areas may be show in color (e.g., as color gradations). Values (e.g., brightness levels) of the various portions of the shaded areas indicate the fit of the garment at different locations of the body of the subject person. For example, darker values may indicate a tighter fit, and lighter values may indicate a looser fit.

In some instances, the menu 3000 may present representations of the subject person wearing the garment in different sizes, and each size may have an associated heat map. For example, FIG. 32 depicts details relating to the “medium” size of the garment. However, responsive to selection of the second part 3104 of the recommendation 3100 shown in FIG. 31, the user interface 1000 may transition to displaying a section of the menu 3000 that is similar to the section shown by FIG. 32 but includes details relating to the “small” size of the garment. The details relating to the “small” size may be displayed along with a representation of the subject person 1004 wearing the garment in the “small” size. Additionally, the representation of the subject person 1004 may be overlaid by a corresponding heat map indicating the fit of the garment at various locations. Selection of the third part 3106 may present information relating to the fit of the garment in the “large” size on the subject person, and selection of the fourth part 3108 may present information relating to the fit of the garment in the “extra large” size on the subject person.

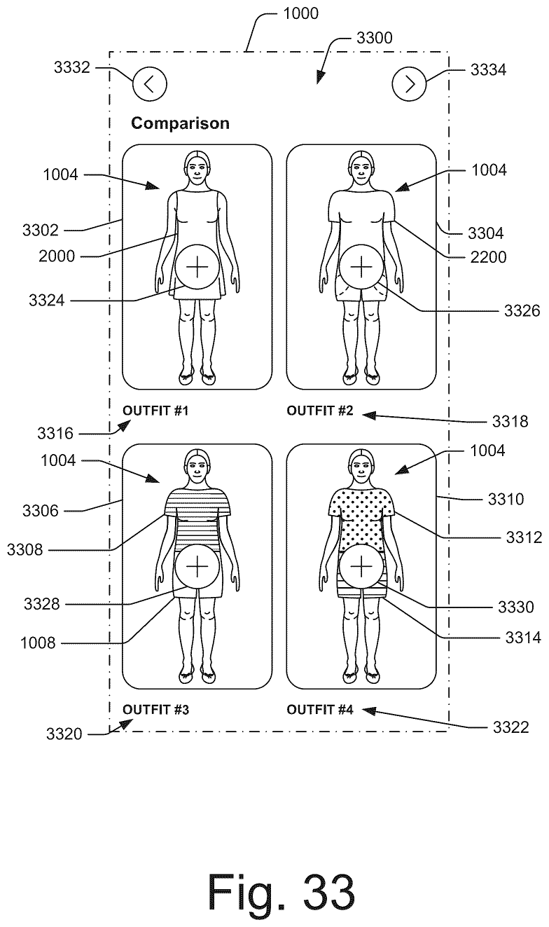

FIGS. 33 through 35 depict the user interface 1000 showing a menu 3300 for outfit comparison. In FIG. 33, the menu 3300 is shown presenting various outfits stored to a user's try-on wardrobe that are available for selection for comparison. In particular, the depicted example shows a first outfit indicator 3302 associated with a first outfit including the dress 2000, a second outfit indicator 3304 associated with a second outfit including the dress 2200, a third outfit indicator 3306 associated with a third outfit including a shirt 3308 and the shorts 1008, and a fourth outfit indicator 3310 associated with a fourth outfit including a shirt 3312 and shorts 3314. The first outfit indicator 3302, the second outfit indicator 3304, the third outfit indicator 3306, and the fourth outfit indicator 3310 are associated with a first outfit description 3316, a second outfit description 3318, a third outfit description 3320, and a fourth outfit description 3322, respectively. The outfit descriptions may be user-defined in some instances.

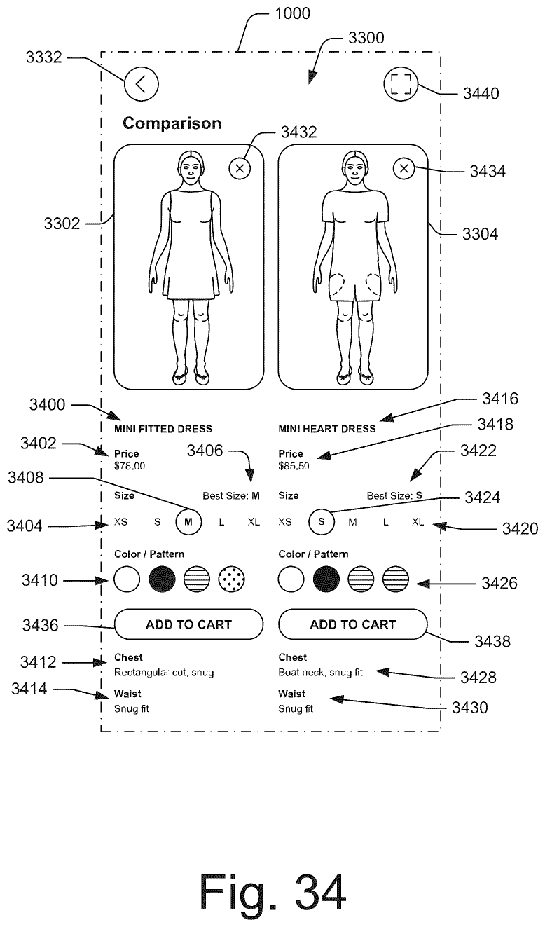

The first outfit indicator 3302 is overlaid with a first add outfit button 3324, the second outfit indicator 3304 is overlaid with a second add outfit button 3326, the third outfit indicator 3306 is overlaid with a third add outfit button 3328, and the fourth outfit indicator 3310 is overlaid with a fourth add outfit button 3330. Selection of one of the add outfit buttons marks the corresponding outfit to be included in a comparison of outfits as described below with reference to FIG. 34. For example, selection of the first add outfit button 3324 marks the first outfit associated with the first outfit indicator 3302 for comparison, and selection of the second add outfit button 3326 marks the second outfit associated with the second outfit indicator 3304 for comparison. The outfits marked for comparison are included in the outfit comparison described below.

The menu 3300 further includes a return button 3332 and an advance button 3334. Selection of the return button 3332 causes the user interface 1000 to transition to displaying the menu most recently displayed prior to the display of the menu 3300. Selection of the advance button 3334 causes the user interface 1000 to transition to presenting a comparison of garments selected via the add outfit buttons as described below.

In FIG. 34, a section of the menu 3300 showing comparison of garments marked for comparison is displayed. In this example, the depicted comparison results from selection of the first outfit and the second outfit for comparison via the first add outfit button 3324 and the second add outfit button 3326, respectively, as described above.

The comparison shows a representation of the subject person wearing the garments included by the first outfit adjacent to a representation of the subject person wearing the garments included by the second outfit. The comparison additionally includes various information relating to each outfit. In the depicted example, the first outfit in the comparison is associated with an outfit description 3400, an outfit price 3402, various size options 3404, a size recommendation 3406, a selected size 3408, various color and/or pattern options 3410, a first fit detail 3412, and a second fit detail 3414. The first fit detail 3412 and the second fit detail 3414 display information relating to the fit of the garments of the first outfit when worn by the subject person. Further, in this example, the second outfit in the comparison is associated with an outfit description 3416, an outfit price 3418, various size options 3420, a size recommendation 3422, a selected size 3424, various color and/or pattern options 3426, a first fit detail 3428, and a second fit detail 3430.

The menu 3300 additionally displays a remove button for each outfit indicator, e.g., a remove button 3432 for the first outfit indicator 3302 and a remove button 3434 for the second outfit indicator 3304. Selection of one of the remove buttons removes the outfit indicator associated with the selected remove button from the comparison. For example, selection of the remove button 3432 removes the first outfit indicator 3302 from the comparison. The menu 3300 also includes an add to cart button for each outfit in the comparison, e.g., an add to cart button 3436 associated with the first outfit indicator 3302 and an add to cart button 3438 associated with the second outfit indicator 3304. Selection of one of the add to cart buttons causes the garments of the outfit associated with the selected button to be marked for purchase (e.g., added to an online cart associated with a user account of the user navigating the user interface 1000). For example, selection of the add to cart button 3436 causes the dress 2000 to be marked for purchase.

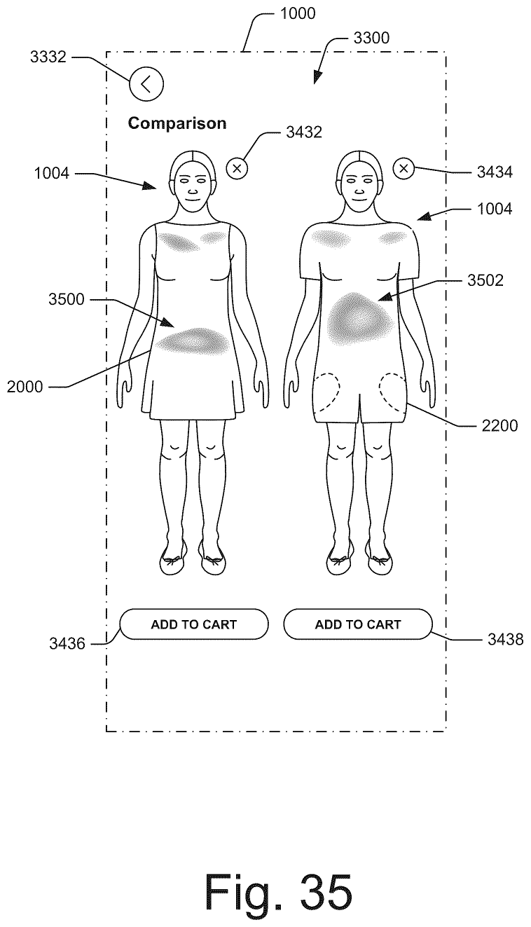

The menu 3300 further displays an enlargement button 3440. Selection of the enlargement button 3440 causes the user interface 1000 to transition to displaying another section of the menu 3300, as described below with reference to FIG. 35.

In FIG. 35, a section of the menu 3300 displayed responsive to selection of the enlargement button 3440 is shown. The depicted section shows enlarged views of the subject person wearing the outfits included in the comparison. In particular, the representation of the subject person wearing the first outfit (e.g., the dress 2000) is presented adjacent to (and concurrently with) the representation of the subject person wearing the second outfit (e.g., the dress 2200). In this configuration, the information relating to the outfits such as the outfit descriptions, outfit prices, size options, and so forth are hidden such that the representations of the subject person are presented in an enlarged manner relative to the configuration depicted by FIG. 34. In some instances, the comparison includes indicators displaying the fit of each outfit. For example, the representation of the subject person wearing the first outfit is shown with shaded areas 3500 indicating the fit of the first outfit on the subject person. The representation of the subject person wearing the second outfit is shown with shaded areas 3502 indicating the fit of the second outfit on the subject person. The try-on management service 114 may employ the garment fit service 216 to determine the fit of each outfit based on extracted measurements of the subject person, for example.

### Example Remote try-on Wardrobe Management and Customization Procedures

The following discussion describes remote fitting techniques that are implementable utilizing the described systems and devices. Aspects of each procedure are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions, thereby creating a special-purpose machine for carrying out an algorithm as illustrated by the flow diagram. As a result, the instructions are stored on a computer-readable storage medium that causes the hardware to perform the algorithm, e.g., responsive to the execution of the instructions. In portions of the following discussion, reference will be made to FIGS. 1-35.

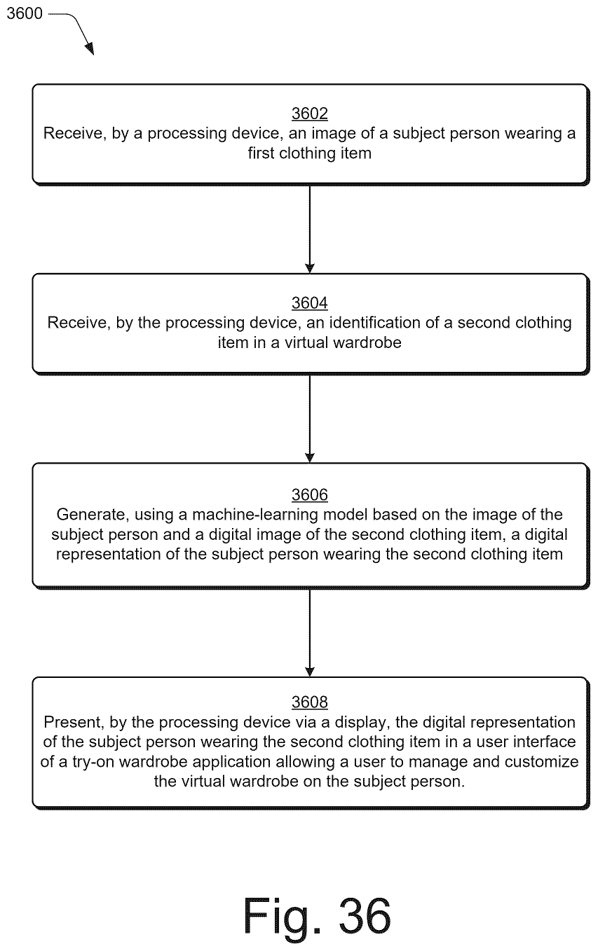

FIG. 36 is a flow diagram depicting an algorithm as a step-by-step procedure 3600 in an example implementation of operations performable for accomplishing a result of remote try-on wardrobe management and customization. To begin, a processing device receives an image of a subject person wearing a first clothing item (block 3602). By way of example, the remote provider system 102 receives the subject image 118 provided to the try-on management service 114.

The processing device receives an identification of a second clothing item in a virtual wardrobe (block 3604). By way of example, the try-on management service 114 receives the customization inputs 120 specifying the garment selections 508, with the second clothing item corresponding to one of the garment selections 508. In this instance, the garment selections 508 correspond to garments in the virtual wardrobe 124.

A machine-learning model generates a digital representation of the subject person wearing the second clothing item based on the image of the subject person and a digital image of the second clothing item (block 3606). By way of example, the try-on management service 114 employs the garment fit service 216 to generate a representation of the individual depicted by the subject image 118 wearing the second clothing item corresponding to one of the garment selections 508.

Finally, the processing device presents, via a display, the digital representation of the subject person wearing the second clothing item in a user interface of a try-on wardrobe application allowing a user to manage and customize the virtual wardrobe on the subject person (block 3608). By way of example, the representation is displayed in the user interface 1000 implemented by the try-on management service 114 via the display 106 of the computer 104.

### Example System and Device

FIG. 37 illustrates an example system 3700, which includes an example computer 3702 that represents one or more computing systems and/or devices usable to implement the techniques described herein. This is illustrated through the inclusion of the try-on management service 3704. The computer 3702 is configurable, for example, as a service provider server, a device associated with a client (e.g., a client device), an on-chip system, and/or any other suitable computing device or computing system.

The example computer 3702, as illustrated, includes a processor 3706, one or more computer-readable media (CRM) 3708, and one or more input/output (I/O) interfaces 3710 that are communicatively coupled, one to another. Although not shown, the computer 3702 includes a system bus or other data and command transfer system that couples the various components. For example, a system bus includes any combination of different bus structures, such as a memory bus or controller, a peripheral bus, a universal serial bus, and/or a processor or local bus that utilizes various bus architectures. Various other examples are also contemplated, such as control and data lines.

The processor 3706 represents the functionality to perform one or more operations using hardware. Accordingly, processor 3706 is illustrated as including hardware elements 3712 that are configured as processors, functional blocks, and so forth. This includes example implementations in hardware as an application specific integrated circuit or other logic device formed using one or more semiconductors. The hardware elements 3712 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 3708 is illustrated as including memory/storage 3714. Memory/storage 3714 represents memory or storage capacity associated with one or more computer-readable media. In one example, the memory/storage 3714 includes volatile media (such as random-access memory (RAM)) and/or nonvolatile media (such as read-only memory (ROM), Flash memory, optical disks, magnetic disks, and so forth). In another example, the memory/storage 3714 includes fixed media (e.g., RAM, ROM, a fixed hard drive, and so on) and removable media (e.g., Flash memory, a removable hard drive, an optical disc, and so forth). The computer-readable media 3708 is configurable in various ways, as described below.

Input/output interface(s) 3710 are representative of functionality to allow a user to enter commands and information to computer 3702 and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, computer 3702 is configurable in various ways to support user interaction, as further described below.

Various techniques are described in the general context of software, hardware elements, or program modules. Generally, such modules include routines, programs, objects, elements, components, data structures, and so forth that perform particular tasks or implement abstract data types. The terms “module,” “functionality,” and “component” as used herein generally represent software, firmware, hardware, or a combination thereof. The features of the techniques described herein are platform-independent, meaning that the techniques are implementable on various commercial computing platforms with various processors.

Implementations of the described modules and techniques are stored on or transmitted across some form of computer-readable media. For example, the computer-readable media includes a variety of media accessible to the computer 3702. By way of example, and not limitation, computer-readable media includes “computer-readable storage media” and “computer-readable signal media.”

“Computer-readable storage media” refers to media and/or devices that enable persistent and/or non-transitory information storage in contrast to mere signal transmission, carrier waves, or signals per se. Thus, computer-readable storage media refers to non-signal-bearing media. The computer-readable storage media includes hardware such as volatile and non-volatile, removable and non-removable media, and/or storage devices implemented in a method or technology suitable for storage of information such as computer-readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium configured to transmit instructions to the hardware of the computer 3702, such as via a network. Signal media typically embodies computer-readable instructions, data structures, program modules, or other data in a modulated data signal, such as carrier waves, data signals, or other transport mechanisms. Signal media also includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 3712 and computer-readable media 3708 are representative of modules, programmable device logic, and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware and hardware utilized to store instructions for execution, e.g., the computer-readable storage media described previously.

Combinations of the foregoing are also employable to implement various techniques described herein. Accordingly, software, hardware, or executable modules are implementable as instructions and/or logic embodied on some form of computer-readable storage media and/or by one or more hardware elements 3712. For example, the computer 3702 is configured to implement particular instructions and/or functions corresponding to the software and/or hardware modules. Accordingly, implementation of a module executable by the computer 3702 as software is achieved at least partially in hardware, e.g., through computer-readable storage media and/or hardware elements 3712 of the processor 3706. The instructions and/or functions are executable/operable by one or more articles of manufacture (for example, one or more computers 3702 and/or processors 3706) to implement techniques, modules, and examples described herein.

The techniques described herein are supportable by various configurations of the computer 3702 and are not limited to the specific examples of the techniques described herein. This functionality is also implementable entirely or partially through a distributed system, such as over a “cloud” 3716, as described below.

Cloud 3716 includes and/or represents a platform 3718 for resources 3720. The platform 3718 abstracts the underlying functionality of hardware (e.g., servers) and software resources of the cloud 3716. For example, resources 3720 include applications and/or data utilized while computer processing is executed on servers remote from the computer 3702. In some examples, the resources 3720 also include services provided over the Internet and/or through a subscriber network, such as a cellular or Wi-Fi network.

Platform 3718 abstracts the resources 3720 and functions to connect the computer 3702 with other computing devices. In some examples, the platform 3718 also serves to abstract scaling of resources to provide a corresponding level of scale to encountered demand for the resources implemented via the platform. Accordingly, in an interconnected device embodiment, the implementation of functionality described herein is distributable throughout system 3700. For example, the functionality is partially implementable on computer 3702 and via platform 3718, which abstracts the functionality of cloud 3716.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

1. A method comprising:
receiving, by a processing device, an image of a subject person wearing a first clothing item;
receiving, by the processing device, an identification of a second clothing item in a virtual wardrobe;
determining, by a first machine-learning model trained to extract body measurements from images of subject persons, measurements of the subject person based on the image of the subject person;
generating, by the processing device, a mesh model of the subject person based on the measurements;
generating, by a second machine-learning model trained to synthesize digital representations of subject persons wearing clothing items, and based on the image of the subject person, the mesh model of the subject person, and a digital image of the second clothing item, a digital representation of the subject person wearing the second clothing item;
presenting, by the processing device via a display, the digital representation of the subject person wearing the second clothing item in a user interface of a try-on wardrobe application allowing a user to manage and customize the virtual wardrobe on the subject person;
receiving, by the processing device via the user interface, a selection of a third clothing item;
generating, by the second machine-learning model, a second digital representation of the subject person wearing the third clothing item, including providing, as inputs to the second machine-learning model, a digital image of the third clothing item and the mesh model of the subject person re-used from generating the digital representation of the subject person wearing the second clothing item; and
presenting. by the processing device via the display, the second digital representation in the user interface.

2. The method of claim 1, further comprising:
receiving, by the processing device via the user interface, a garment image depicting a fourth clothing item;
determining, by the processing device using another machine-learning model and based on the garment image, similarity between the fourth clothing item and one or more other clothing items;
determining, by the processing device based on the similarity, a fifth clothing item from the one or more other clothing items; and
presenting the fifth clothing item in the user interface.

3. The method of claim 1, wherein receiving the identification of the second clothing item includes:
receiving, by the processing device via the user interface, a garment image depicting a fourth clothing item;
determining, by the processing device using another machine-learning model and based on the garment image, similarity between the fourth clothing item and one or more other clothing items; and
identifying, by the processing device, the second clothing item from the one or more other clothing items based on the similarity.

4. The method of claim 1, further comprising:
receiving, by the processing device via the user interface, a selection for adjustment of body features of the subject person including at least one of skin tone or cosmetics;
generating, by the processing device, a touch-up image depicting the subject person with the body features adjusted based on the selection; and
presenting, by the processing device via the display, the touch-up image in the user interface.

5. (canceled)

6. The method of claim 1, further comprising:
determining, by the second machine-learning model, a fit of the second clothing item on the subject person and a fit of the third clothing item on the subject person based on the measurements; and
presenting, by the processing device via the display, an indication of the fit of the second clothing item on the subject person and an indication of the fit of the third clothing item on the subject person in the user interface.

7. The method of claim 1, wherein the second digital representation depicts the subject person wearing the second clothing item layered with the third clothing item.

8. The method of claim 1, further comprising:
receiving, by the processing device via the user interface, natural language input;
generating, by another machine-learning model, a recommendation relating to the second clothing item or another clothing item based on the natural language input; and
presenting, by the processing device via the display, the recommendation in the user interface.

9. The method of claim 1, further comprising:
receiving, by the processing device via the user interface, natural language input; and
responsive to receiving the natural language input:
determining, by the second machine-learning model, a fit of a garment on the subject person based on the measurements, where the garment is the second clothing item or another clothing item; and
presenting, by the processing device via the display, a representation of the fit of the garment on the subject person in the user interface.

10. (canceled)

11. The method of claim 1, further comprising:
receiving, by the processing device via the user interface, natural language input;
determining, using another machine-learning model, a background for the subject person based on the natural language input;
generating, by the processing device, a representation of the subject person in an environment defined by the background; and
presenting, by the processing device, the representation of the subject person in the environment in the user interface.

12. (canceled)

13. The method of claim 1, further comprising:
receiving, by the processing device, a pose selection specifying a pose for the subject person;
generating, by a third machine-learning model trained to generate representations of subject persons in selected poses, a representation of the subject person in the pose specified by the pose selection based on the measurements; and
presenting, by the processing device via the display, the representation of the subject person in the pose specified by the pose selection in the user interface.

14. A computing device, comprising:
a memory; and
a processor configured to:
receive an image of a subject person wearing a first clothing item;
receive an identification of a second clothing item in a virtual wardrobe;
determine, by a first machine-learning model trained to extract body measurements from images of subject persons, measurements of the subject person based on the image of the subject person;
generate a mesh model of the subject person based on the measurements;
generate, by a second machine-learning model trained to synthesize digital representations of subject persons wearing clothing items, and based on the image of the subject person, the mesh model of the subject person, and a digital image of the second clothing item, a digital representation of the subject person wearing the second clothing item;
present the digital representation of the subject person wearing the second clothing item in a user interface of a try-on wardrobe application allowing a user to manage and customize the virtual wardrobe on the subject person:
receive, via the user interface, a selection of a third clothing item;
generate, by the second machine-learning model, a second digital representation of the subject person wearing the third clothing item, including providing. as inputs to the second machine-learning model, a digital image of the third clothing item and the mesh model of the subject person re-used from generating the digital representation of the subject person wearing the second clothing item; and
present the second digital representation in the user interface.

15. The computing device of claim 14, wherein the processor is further configured to:
receive, via the user interface, a garment image depicting a fourth clothing item;
determine, using another machine-learning model and based on the garment image, similarity between the fourth clothing item and one or more other clothing items;
determine, based on the similarity, a fifth clothing item from the one or more other clothing items; and
present the fifth clothing item in the user interface.

16. The computing device of claim 14, wherein the processor is further configured to:
receive, via the user interface, a selection for adjustment of body features of the subject person including at least one of skin tone or cosmetics;
generate a touch-up image depicting the subject person with the body features adjusted based on the selection; and
present the touch-up image in the user interface.

17. (canceled)

18. The computing device of claim 14, wherein the processor is further configured to:
receive, via the user interface, natural language input;
generate, by another machine-learning model, a recommendation relating to the second clothing item or another clothing item based on the natural language input; and
present the recommendation in the user interface.

19. The computing device of claim 14, wherein the processor is further configured to:
receive, via the user interface, natural language input;
determine, using another machine-learning model, a background for the subject person based on the natural language input;
generate a representation of the subject person in an environment defined by the background; and
present the representation of the subject person in the environment in the user interface.

20. One or more computer-readable storage media storing instructions that, responsive to execution by a processing device, cause the processing device to:
receive an image of a subject person wearing a first clothing item;
receive an identification of a second clothing item in a virtual wardrobe;
determine, by a first machine-learning model trained to extract body measurements from images of subject persons, measurements of the subject person based on the image of the subject person;
generate a mesh model of the subject person based on the measurements, the mesh model comprising a parametric model that represents the subject person using a fixed set of parameters, one or more parameters of the fixed set of parameters adjusted based on the measurements;
generate, by a second machine-learning model trained to synthesize digital representations of subject persons wearing clothing items, the second machine-learning model comprising a generative adversarial network, and based on the image of the subject person, the mesh model of the subject person, and a digital image of the second clothing item, a digital representation of the subject person wearing the second clothing item;
present the digital representation of the subject person wearing the second clothing item in a user interface of a try-on wardrobe application allowing a user to manage and customize the virtual wardrobe on the subject person;
receive, via the user interface, a selection of a third clothing item;
generate, by the second machine-learning model, a second digital representation of the subject person wearing the third clothing item, including providing, as inputs to the second machine-learning model, a digital image of the third clothing item and the mesh model of the subject person re-used from generating the digital representation of the subject person wearing the second clothing item; and
present the second digital representation in the user interface.

21. The method of claim 1, wherein the mesh model comprises a parametric model that represents the subject person using a fixed set of parameters, and wherein generating the mesh model includes adjusting one or more parameters of the fixed set of parameters based on the measurements.

22. The method of claim 1, wherein the second machine-learning model comprises a generative adversarial network, and wherein generating the digital representation of the subject person wearing the second clothing item includes synthesizing, by the generative adversarial network, the digital representation based on the mesh model of the subject person, the image of the subject person, and the digital image of the second clothing item.

23. The method of claim 1, further comprising:
receiving, by the processing device via the user interface, a selection of a color variation of the second clothing item;
generating, by the second machine-learning model, a third digital representation of the subject person wearing the second clothing item in the color variation; and
presenting, by the processing device via the display, the third digital representation concurrently with the digital representation of the subject person wearing the second clothing item in the user interface.

24. The method of claim 13, wherein the representation of the subject person in the pose specified by the pose selection depicts the subject person wearing the second clothing item, and wherein the pose specified by the pose selection is a rear-facing pose such that the representation provides a preview of a rear view of the second clothing item as worn by the subject person.
